(19) United States
(12) Patent Application Publication
(10) Pub. No.: US 2023/0407106 A1
(43) Pub. Date: Dec. 21, 2023

(54) BIO-BASED MONOMERS AND POLYMERS MADE THEREFROM

(71) Applicant: Columbia Insurance Company, Omaha, NE (US)

(72) Inventors: Yong Yang, Hillsborough, NJ (US); Gary Dandreaux, River Edge, NJ (US); Cristian Grigoras, Suffern, NY (US); Changfeng Chen, Ridgewood, NJ (US); Richard Geurtsen, Robbinsville, NJ (US)

(21) Appl. No.: 18/223,268

(22) Filed: Jul. 18, 2023

Related U.S. Application Data
(63) Continuation-in-part of application No. 18/016,960, filed on Jan. 19, 2023.
(60) Provisional application No. 63/063,594, filed on Aug. 10, 2020.
(60) Provisional application No. 63/074,189, filed on Sep. 3, 2020.
(60) Provisional application No. 63/131,469, filed on Dec. 29, 2020.

(51) Int. Cl. C09D 5/16; C09D 133/14; C09D 7/63; C08F 20/30; C08K 5/17; C08K 5/24

(52) U.S. Cl. CPC C09D 5/1668; C09D 133/14; C09D 7/63; C08F 20/30; C08K 5/17; C08K 5/24

(57) ABSTRACT

Disclosed are architectural compositions, including aqueous paint and stain compositions, that utilized copolymers including bio-based cross-linking monomers and their synthetic analogues that are comparable to copolymers including DAAM cross-linking monomers. The bio-based cross-linking monomers are preferably synthetic version of the bio-based cross-linking monomers.

### CROSS-REFERENCE TO RELATED PATENT APPLICATION

The present application is a continuation-in-part under 35 United States Code Section 120 of U.S. patent application Ser. No. 18/016,960 filed on 19 Jan. 2023, which claims priority to international patent application No. PCT/US2021/045314 filed on 10 Aug. 2021, which claims priority to U.S. provisional patent application No. 63/063,594 filed on 10 Aug. 2020, U.S. provisional patent application No. 63/074,189 filed on 3 Sep. 2020 and U.S. provisional patent application No. 63/131,469 filed on 29 Dec. 2020. All parent patent applications are incorporated herein by reference in their entireties.

### FIELD OF THE INVENTION

The present invention relates to a novel class of bio-based monomers and homopolymers and to novel copolymers made from the new bio-based monomers. The present invention is also related to a new class of cross-linkable bio-based monomers that when one or more of the bio-based monomers are polymerized with other monomer(s), a film-forming polymer is produced which can be used in architectural compositions. The film-forming polymer crosslinks with a cross-linking agent in the liquid phase into a solid film when the architectural composition is applied to a substrate and the liquid phase evaporates.

### BACKGROUND OF THE INVENTION

Bio-based and/or renewable compounds such as vanillin and vanillin alcohol, originally extracted from vanilla plantifolia beans and more recently from lignin, have been utilized in the cosmetic and fragrant industries and have been used to flavor foods and drinks. Vanillin and vanillin alcohol have been synthesized into monomers with hydroxy and aldehyde reaction sites. These monomers can be homopolymerized or copolymerized, as discussed in U.S. published patent application no. US2018/0201703 to Kessler et al (methacrylated vanillin (MV) and methacrylated vanillyl alcohol (MVA)) and in U.S. published patent application no. US 2014/0275435 to Holmberg et al., which are incorporated by reference herein in their entireties.

To form a stronger solid paint film from aqueous architectural compositions, a cross-linkable monomer, such as diacetone acrylamide (DAAM), is copolymerized with other monomers, such as acrylic, vinyl, styrene and/or urethane monomers, to form latex resin binders. After the architectural compositions are applied to a substrate and the aqueous phase evaporates, the DAAM moiety utilizing its ketone reaction site reacts in the aqueous phase with a crosslinking compound, such as a diamine or a dihydrazide compound, such as adipic acid dihydrazide (ADH), to self-crosslink the latex resins to form stronger paint films, e.g., films with higher resistance to scrubbing. Such cross-linking or self-cross-linking mechanism is discussed in commonly owned U.S. Pat. No. 9,040,617 B2, which is incorporated herein by reference in its entirety.

The utility of bio-based monomers as a cross-linkable monomer in film-forming latex resins in architectural compositions is not yet known, due to the fact that the aldehyde reaction site is different from the ketone reaction site on the DAAM monomer. Hence, there remains a need for other cross-linkable monomers, preferably bio-based cross-linkable monomers and synthetic analogue of the bio-based monomers, that function similar to or better than DAAM in architectural compositions.

### SUMMARY OF THE INVENTION

Hence, the present invention relates to a class of bio-based monomers, their synthetic analogues and homopolymers thereof, and to novel copolymers made from the bio-based monomers and their synthetic analogues. The present invention is also related to a class of cross-linkable bio-based monomers or their synthetic analogues that when one or more of the bio-based monomers or their synthetic analogues are co-polymerized with other monomer(s) forms a film-forming polymer used in architectural compositions. The film-forming polymer crosslinks with a cross-linking agent in the liquid phase into a solid film when the architectural composition is applied to a substrate and the liquid phase evaporates.

The present invention is also directed to a class of methacrylate monomers comprising a bio-based moiety and a reactive ketone moiety.

The present invention is further directed to a class of methacrylate monomers comprising synthetically made bio-based moiety and a reactive ketone moiety.

An embodiment of the present invention is directed to an aqueous architectural coating comprising an optional opacifying pigment, a film-forming copolymer resin, and a diamine or a dihydrazide compound dispersed in an aqueous phase,
wherein the film-forming copolymer resin includes at least one film-forming monomer, and a cross-linkable monomer with a structure:

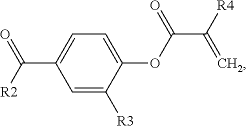

where R2 is H or CH₃; R3 is OCH₃; and R4 is CH₃,
wherein the cross-linkable monomer is a synthetic analogue of the bio-based monomer, and wherein the at least one film-forming monomer comprises a (meth)acrylate monomer and an optional styrene monomer, and
wherein the copolymer resin is capable of forming a film on a substrate after the aqueous architectural coating is applied on said substrate and the aqueous phase evaporates.

In this embodiment, the synthetic analogue of the bio-based cross-linkable monomer in the film-forming copolymer resin ranges from about 0.008 mole % to about 0.025 mole %, preferably from about 0.010 mole % to about 0.0225%, preferably from about 0.010 mole % to about 0.020 mole % based on total monomers in the film-forming copolymer resin.

In this embodiment, the synthetic analogue of the bio-based cross-linkable monomer in the film-forming copolymer resin ranges from about 2.0 wt. % to about 6.0 wt. %, preferably from about 2.25 wt. % to about 5.5 wt. %, preferably from about 2.5 wt. % to about 5.0 wt. % based on total monomers in the film-forming copolymer resin.

Another embodiment of the present invention is directed to an aqueous architectural coating comprising an optional opacifying pigment, a film-forming copolymer resin, and a diamine or a dihydrazide compound dispersed in an aqueous phase,
wherein the film-forming copolymer resin includes at least one film-forming monomer, and a cross-linkable monomer with either the following structure:

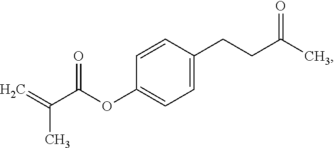 [SMILES: C=C(C)C(=O)Oc1ccc(CCC(C)=O)cc1]

or the following structure

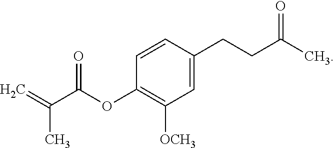 [SMILES: C=C(C)C(=O)Oc1ccc(CCC(C)=O)cc1OC]

wherein the cross-linkable monomer is a synthetic analogue of the bio-based monomer, and wherein the at least one film-forming monomer comprises a (meth)acrylate monomer and an optional styrene monomer, and
wherein the copolymer resin is capable of forming a film on a substrate after the aqueous architectural coating is applied on said substrate and the aqueous phase evaporates.

In this embodiment, the synthetic analogue of the bio-based cross-linkable monomer in the film-forming copolymer resin ranges from about 0.008 mole % to about 0.025 mole %, preferably from about 0.010 mole % to about 0.0225%, preferably from about 0.010 mole % to about 0.020 mole % based on total monomers in the film-forming copolymer resin.

In this embodiment, the synthetic analogue of the bio-based cross-linkable monomer in the film-forming copolymer resin ranges from about 2.0 wt. % to about 6.0 wt. %, preferably from about 2.25 wt. % to about 5.5 wt. %, preferably from about 2.5 wt. % to about 5.0 wt. % based on total monomers in the film-forming copolymer resin.

Another embodiment of the present invention is directed to a method for selecting a bio-based cross-linkable monomer with respect to a diacetone acrylamide (DAAM) monomer, wherein the bio-based cross-linkable monomer is copolymerized to form a bio-based film-forming copolymer resin capable of crosslinking using the diamine or dihydrazide compound to form a bio-based paint film on a substrate, said method comprises the steps of
(i) ascertaining a scrubbability of the bio-based paint film, wherein if said scrubbability is greater than 1,000 cycles, or is within 20%, preferably within 15%, preferably within 10%, in terms of the number of cycles of a standard paint film formed with a standard film-forming copolymer resin with DAAM, then the scrubbability is acceptable;
(ii) ascertaining a cleansability of the bio-based paint film, wherein if said cleansability is less than 2.0 CIEDE2000 units, or has a lower reading with a spectrophotometer than that of the standard paint film, then the cleansability is acceptable;
(iii) ascertaining a tack resistance of the bio-based paint film, wherein if said tack resistance is within 7.5 units, preferably within 5 units, preferably within 2.5 units, of the tack resistance of the standard paint film, then the tack resistance is acceptable;
(iv) ascertaining the block resistance of the bio-based paint film, wherein if said block resistance is the same as, or better than, or is within 1.0 unit of the block resistance of the standard paint film, then the block resistance is acceptable
wherein if the bio-based paint film possesses at least two acceptable ratings out of four in steps (i)-(iv), as compared to the standard paint film, then said bio-based cross-linkable monomer is acceptable, and
wherein the DAAM crosslinking monomer is present in the standard film-forming copolymer resin within ±5% mole percentage as the bio-based cross-linkable monomer is present in the bio-based film-forming copolymer resin.

In this method, the bio-based cross-linkable monomer also comprises a synthetic analogue thereof.

Another embodiment is directed to a bio-based film-forming copolymer resin selected in accordance with said methods.

### BRIEF DESCRIPTION OF THE DRAWINGS

In the accompanying drawings, which form a part of the specification and are to be read in conjunction therewith and in which like reference numerals are used to indicate like parts in the various views:

FIG. 1 is a photograph of a TLC test of samples of raspberry ketone and the inventive frambinone methacrylate (FMA) monomer, and a mixture of both.

FIG. 2 shows a ¹³C-NMR spectrum of the inventive frambinone methacrylate monomer.

FIG. 3 shows a ¹H-NMR spectrum of the inventive frambinone methacrylate monomer.

FIG. 4 shows a FTIR spectrum of raspberry ketone.

FIG. 5 shows a FTIR spectrum of the inventive frambinone methacrylate monomer;

FIG. 6 shows the FTIR spectra of both FIGS. 4 and 5.

FIGS. 7(a)-(b) show the results of a GC-MS analysis of the crude frambinone methacrylate monomer product mixture.

FIGS. 8(a)-(c) show the MS results on some of the impurities present in the crude product mixture of FIG. 7(a); these were identified as methacrylic anhydride, raspberry ketone and raspberry ketone acetate constituents, respectively.

FIG. 9 shows the FTIR spectra of the inventive monomer frambinone methacrylate and of the frambinone methacrylate homopolymer.

FIG. 10 is a DSC plot of the homopolymer of frambinone methacrylate showing its glass transition temperature (Tg).

FIGS. 11(A)-(D) are photographs of dried film samples of an inventive FMA-containing copolymer, and a comparative copolymer, each with and without ADH, after a swell ratio test.

FIG. 12 is a photograph of a TLC test of samples of zingerone and the inventive zingerone methacrylate (ZMA) monomer, and a mixture of both.

FIG. 13 shows a ¹³C-NMR spectrum of the inventive zingerone methacrylate monomer.

FIG. 14 shows a ¹H-NMR spectrum of the inventive zingerone methacrylate monomer.

FIG. 15 shows a FTIR spectrum of zingerone.

FIG. 16 shows a FTIR spectrum of the inventive zingerone methacrylate monomer.

FIG. 17 shows the FTIR spectra of both FIGS. 15 and 16.

FIG. 18 is DSC plots of the ZMA monomer showing its glass transition temperature (Tg).

FIGS. 19 (A)-(F) are photographs of dried film samples of a copolymer containing DAAM, FMA, ZMA each with and without ADH, after a swell ratio test; and FIG. 19(G) shows the legends and descriptions of the dried film samples in FIGS. 19 (A)-(F).

### DETAILED DESCRIPTION OF THE PREFERRED EMBODIMENTS

Compounds, including but not limited to bio-based or renewable compounds, with a ketone reaction site

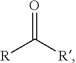

similar to DAAM were investigated and synthesized to produce monomers that could be polymerized into homopolymers, co-polymers and as cross-linkable moieties on co-polymers. Exemplary compounds with ketone reaction site include, but are not limited to, raspberry ketone, zingerone, vanillin and acetovanillone (also known as apocynin). Additional suitable compounds are discussed below.

In one embodiment, raspberry ketone is utilized as a starting material. Raspberry ketone is a naturally occurring compound and is the primary aromatic compound of red raspberry. Raspberry ketone can also be found in cranberries and blackberries and can be extracted from these fruits. Raspberry ketone can also be synthesized from non-bio sources. Raspberry ketone is also known as 4-(4-hydroxyphenyl)butan-2-one (IUPAC); p-hydroxybenzyl acetone; 4-(p-hydroxyphenyl)-2-butanone; frambinone; oxyphenylon; rheosmin and rasketone. Structurally, raspberry ketone comprises an aromatic phenyl ring connected at one end to a reactive hydroxy (—OH) reaction site and at the other end to a ketone reaction site albeit through spacers or intervening atoms, as shown below.

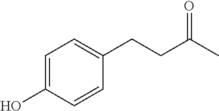

The present inventors believe that the hydroxy reaction site allows raspberry ketone to react with another compound or a monomer to be synthesized into a novel monomer. A preferred compound or monomer is methacrylic anhydride, which is a reactive monomer that can be used to prepare other monomers. Methacrylic anhydride has two acyl groups bonded to a single oxygen, and has the following structure,

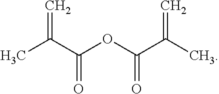

### Example 1. Bi-Phasic Reaction Between Raspberry Ketone and Methacrylic Anhydride

To a solution of raspberry ketone, methacrylic anhydride and dimethylaminopyridine (DMAP) catalyst in dichloromethane (CH₂Cl₂) solvent was added an aqueous 16 wt. % solution of sodium hydroxide (NaOH). Dichloromethane is immiscible with water and is heavier than water (density 1.33 g/ml). The mixture was stirred for about ½ hour at room temperature (RT or about 77° F.). This procedure is much more efficient (near quantitative consumption of raspberry ketone starting material) than either the neat reaction of raspberry ketone with acetic anhydride in the presence of DMAP at elevated temperature, or the solvent-less biphasic reaction of raspberry ketone and acetic anhydride with a 16 wt. % aqueous solution of NaOH at RT. The organic phase was isolated and washed with respectively, deionized (DI) water, a 10 wt. % aqueous solution of hydrochloric acid (HCl), DI water, a 10 wt. % aqueous solution of sodium bicarbonate (NaHCO₃), and DI water. The organic phase was isolated and dried over magnesium sulfate (MgSO₄). The solution was then filtered, and evaporated to yield a new monomer, frambinone methacrylate (FMA), or raspberry ketone methacrylate (RKMA), as a clear, colorless liquid at RT. Upon aging, it is possible that the material will undergo a phase transition into a waxy, off-white solid.

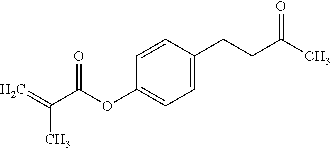 [SMILES: C=C(C)C(=O)Oc1ccc(CCC(C)=O)cc1]

As shown, the raspberry ketone's hydroxy reaction site was utilized to react and bond to an acyl moiety of the methacrylic anhydride. In this Example, 1.1 mole of methacrylic anhydride was used to react with 1 mole of raspberry ketone. Other than the resulting frambinone methacrylate monomer, the other compounds remaining in the mixture include the residual starting materials raspberry ketone and methacrylic anhydride.

The synthesis of frambinone methacrylate was confirmed through analytical tools, such as thin layer chromatography (TLC), ¹H-NMR and ¹³C-NMR (nuclear magnetic resonance) spectroscopy focusing on hydrogen and carbon-13 respectively, Fourier Transform Infrared (FTIR) spectroscopy experiments, and gas chromatography-mass spectrometry (GC-MS), as described below.

Thin Layer Chromatograph (TLC). Samples of a mixture containing both frambinone methacrylate and raspberry ketone, only frambinone methacrylate and only raspberry ketone, were spotted or deposited proximate to a bottom end of a support substrate, e.g., aluminum or glass, covered by a stationary phase, which typically is silica gel. The TLC test measures the affinity of each composition in the samples to the stationary phase and to a mobile phase, which is a solvent or mixture of solvents. The support substrate with the samples spotted thereon is vertically held with the bottom end in the solvent, and the solvent moves up the support substrate via capillary action. The different compounds would move up the support substrate at different rate or distance depending on their polarities. Generally, the more polar compounds move up the support substrate slower than the less polar compounds.

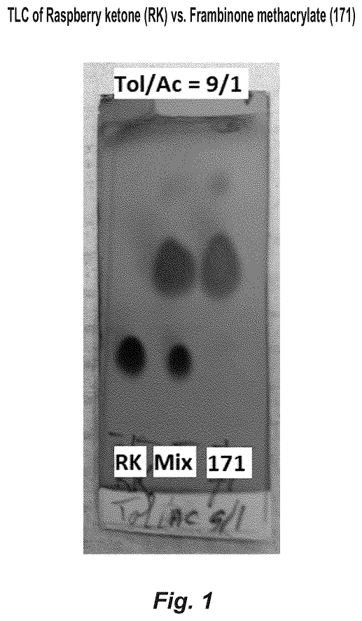

As best shown in FIG. 1, a raspberry ketone spot is deposited on the left-hand side, and a frambinone methacrylate, labeled as “171,” is deposited on the right-hand side. A spot that contains a mixture of both is deposited in between. The support substrate was turned vertically with the spots proximate the bottom and then the spots were eluted, i.e., to remove or move an adsorbed substance upward by washing with a solvent mixture, which comprises about 90% toluene and about 10% acetone. FIG. 1 shows that the raspberry ketone spot moved a first short distance upward and the frambinone methacrylate spot moved a second longer distance upward. Instructively, the spot of the mixture separated into two spots: one at the first distance of the raspberry ketone and another at the second distance of the frambinone methacrylate. The TLC test shows that frambinone methacrylate is different than or at least has a different polarity (is more hydrophobic) than the starting material raspberry ketone.

The retention factor (R_{f}), which is a ratio of the distance the frambinone methacrylate had moved up to the distance that the solvent mixture had moved up the support substrate, can be used to quantify TLC analyses. The R_{f} for frambinone methacrylate in FIG. 1 is about 0.55 and the R_{f} value of the Raspberry ketone is about 0.25.

Nuclear Magnetic Resonance (NMR) Spectroscopy. NMR spectroscopy measures selective absorption of high frequency radio waves by certain atomic nuclei that are subjected to an external magnetic field. A sample is placed in this magnetic field, and NMR signals are produced when nuclei aligned with the external magnetic field are excited into a state opposed to it by radio frequency (RF) waves, and the subsequent emission of absorbed RF energy is measured. The intramolecular magnetic field of an atom in a molecule changes the resonance frequency required for this magnetic field “flip”, thereby providing information about molecular structure and functional groups. Two NMR experiments were conducted on the frambinone methacrylate. ¹³C-NMR is tuned to carbon-13. While the most common carbon isotope is carbon-12, which does not show up in NMR, there is a sufficient number of carbon-13 atoms present in organic molecules to reveal information about their structure. ¹H-NMR is tuned to hydrogen nuclei (commonly referred to as protons). Frambinone methacrylate's structure with the carbons labeled from “a”-“l” and frambinone methacrylate's structure with the hydrogens labeled from “a”-“h,” respectively, are shown below.

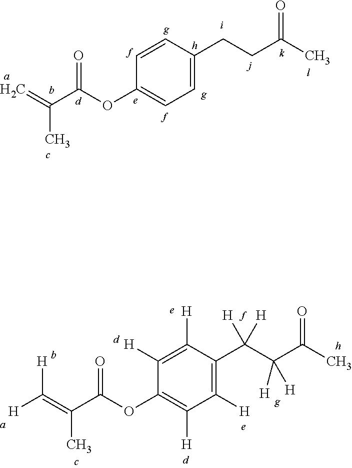 [SMILES: C=C(C)C(=O)Oc1ccc(CCC(C)=O)cc1 ; C=C(C)C(=O)Oc1ccc(CCC(C)=O)cc1]

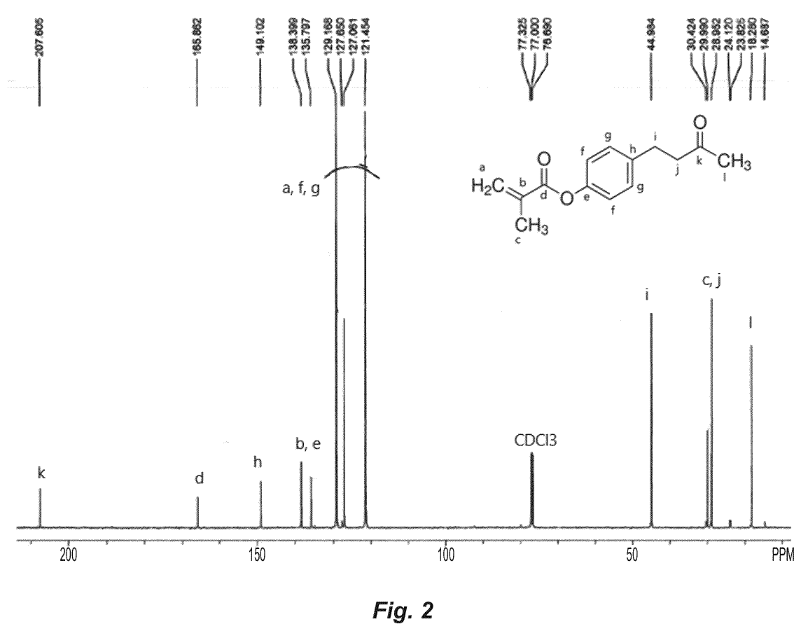

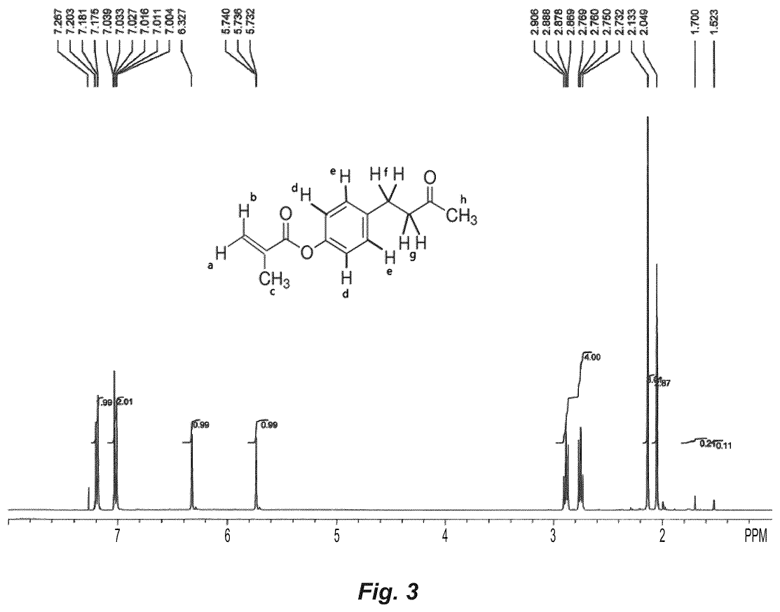

NMR analysis is usually conducted on a sample dissolved in a solvent. Because of the hydrophobic nature of the inventive monomer, deuterochloroform (CDCl₃) is used as the solvent in the experiments. In CDCl₃, hydrogen is replaced by its isotope deuterium to avoid signals from the hydrogen nuclei. The NMR instrument for FIG. 2 is rated at 100 MHz, which means that the instrument has a magnetic field in which hydrogen atoms resonate at 100 MHz. The NMR for FIG. 3 is rated at 400 MHz. Two peaks on a NMR graph that are 100 Hz apart from a 100 MHz instrument would be 300 Hz apart on a 300 MHz instrument and would be 400 Hz apart on a 400 MHz instrument, and so on. To normalize the horizontal axes on NMR graphs the frequency separation of the peaks is divided by the base resonance frequency to yield a ratio that when multiplied by 106 yields a value of ppm (parts per million).

FIG. 2 shows peaks for all of the carbon nuclei “a”-“l,” as well as the characteristic triplet peak for deuterochloroform at 77 ppm. ¹³C NMR data (CDCl₃, 100 MHz): δ 207.6 (k), 165.9 (d), 149.1 (h), 138.4 (b), 135.8 (e), 129.2, 127.1, and 121.5 (a, f, and g), 77.3, 77.0, and 76.7 (CDCl₃), 45.0 (i), 30.0 and 29.0 (c and j), 18.3 (l).

FIG. 3 shows the peaks for all of the proton/hydrogen nuclei “a”-“h” with a small peak for the chloroform present in deuterochloroform at 7.3 ppm. In ¹³C-NMR, signal intensity is in the order of (large to small): CH₃>CH₂>CH>C-quaternary or carbonyl. In the proton spectrum, the integral is directly correlated to the amount of protons present. Splitting of the signal reveals information on how many neighboring protons there are, and on chemical structure. ¹H NMR data (CDCl₃, 400 MHz): δ 7.27 (CHCl₃), 7.19 and 7.02 (2×multiplet, CH phenyl, d and e), 6.33 (multiplet, CH vinyl, b), 5.74 (multiplet, CH vinyl, a), 2.89 (triplet, CH₂, f/g, J_{f,g} 7.6 Hz), 2.75 (triplet, CH₂, f/g, J_{f,g} 7.6 Hz), 2.13 (singlet, CH₃, h), 2.05 (singlet, CH₃, c).

Fourier Transform Infrared (FTIR) Spectroscopy. FTIR spectroscopy measures the absorption of electromagnetic radiation in the infrared range (wavelengths from about 760 nm to about 10³ μm). A broad band of electromagnetic radiation covering the IR range is exposed to a sample containing the test composition. An interferometer, such as a Michelson interferometer, receives the absorption signals from the sample and a computer utilizing the Fourier Transformation technique converts the data into information about the various segments or moieties from the test composition. Look-up tables containing absorption data for various moieties and functional groups, e.g., O—H, C—H, N—H, O═C═O, etc., at various frequencies (cm⁻¹) are used to identify the various moieties on the test composition. It is known that frequencies, also known as wavenumbers, and wavelengths are inverse of each other. An exemplary look-up table is available at sigmaaldrich.com/technical-documents/articles/biology/ir-spectrum-table.html.

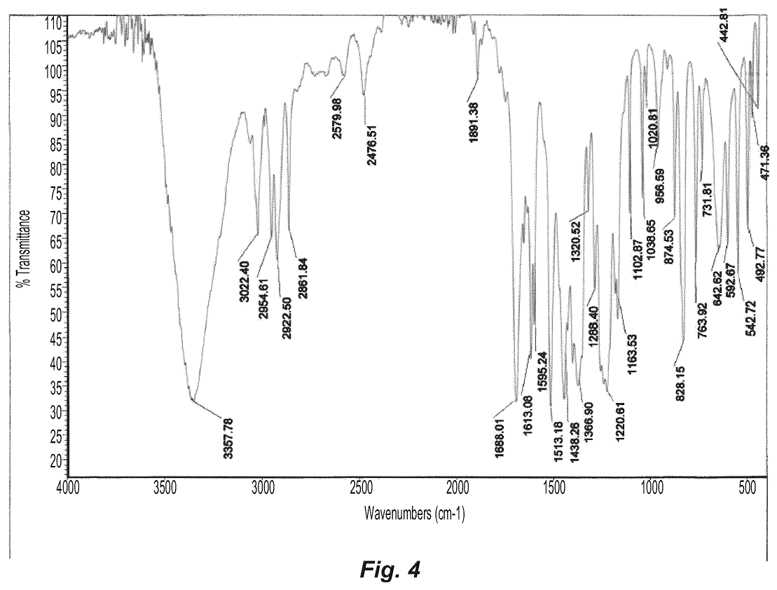

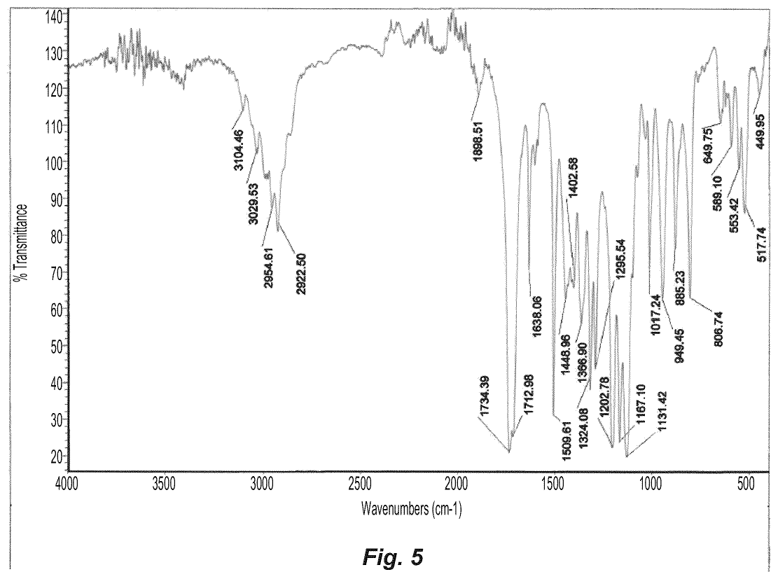

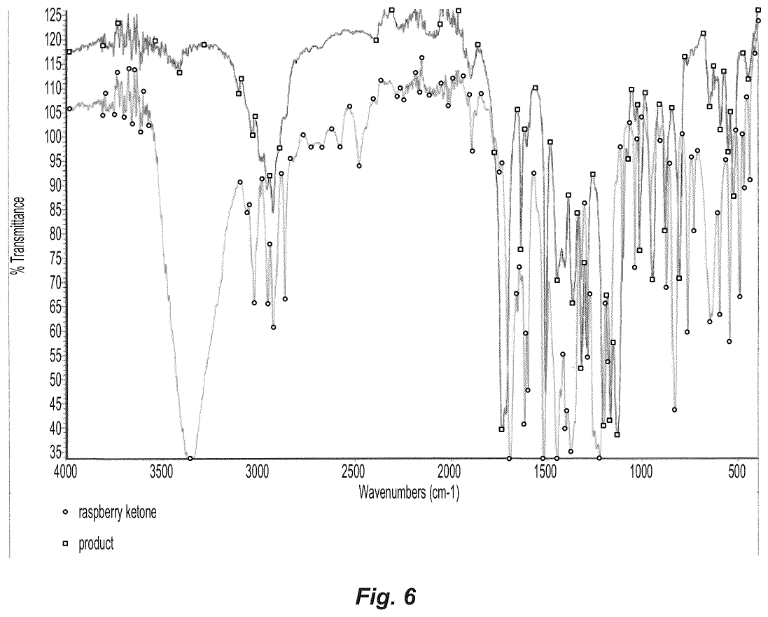

FIG. 4 is a FTIR spectrum of raspberry ketone showing the various moieties at their respective frequencies. Of notes are the dip at 3358 cm⁻¹, which represents the phenol-hydroxy segment, and the ketone segment at 1688 cm⁻¹. FIG. 5 is a FTIR spectrum of the inventive frambinone methacrylate and FIG. 6 is a superposition of both spectra from FIGS. 4 and 5 with the spectrum for frambinone methacrylate substantially on top of the spectrum for raspberry ketone. FIG. 6 shows the disappearance of the phenol-hydroxy moiety in the frambinone methacrylate monomer, which confirms that the hydroxy reaction site was used in the reaction. The ester ketone spike was shifted slightly to 1713 cm⁻¹ and the occurrence of the methacrylate carbonyl at 1734 cm⁻¹ and C═C vinyl at 1638 cm⁻¹ are indicative of the synthesis of a new composition. FTIR data (in cm⁻¹): 3105-2929 (broad, multiple peaks), 1899 (weak), 1734, 1713, 1638, 1510, 1449, 1403, 1367, 1324, 1296, 1203, 1167, 1131, 1017, 949, 885, 807, 650 (weak), 569, 553, 518, 450 (weak).

Gas Chromatography-Mass Spectrometry (GC-MS). The GC-MS technique is a combination of gas chromatography (GC) and mass spectrometry (MS). In the GC portion, a carrier gas, which is typically helium, nitrogen or hydrogen, containing a sample mixture to be analyzed, known as the mobile phase, passes through a length or column of glass or metal containing a microscopic layer of liquid or polymer deposited on an insert support, known as the stationary phase. The gaseous mobile phase interacts with the stationary phase and each constituent of the sample mixture will elute at different time, known as retention time. The constituents are ionized by a bombardment of electrons in the MS portion. The molecules of the constituents and fragments thereof are charged and are separated according to their mass to charge ratio (m/z) by subjecting them to an electric or magnetic field. Their mass to charge ratio is related to the path of the charged molecules to a detector. The relative signal intensity is plotted as a function of m/z. The combination of GC and MS increases the accuracy of the identification of the molecules to be analyzed, because if MS identifies a molecule that has a corresponding GC retention time then the identification of that molecule is more assured.

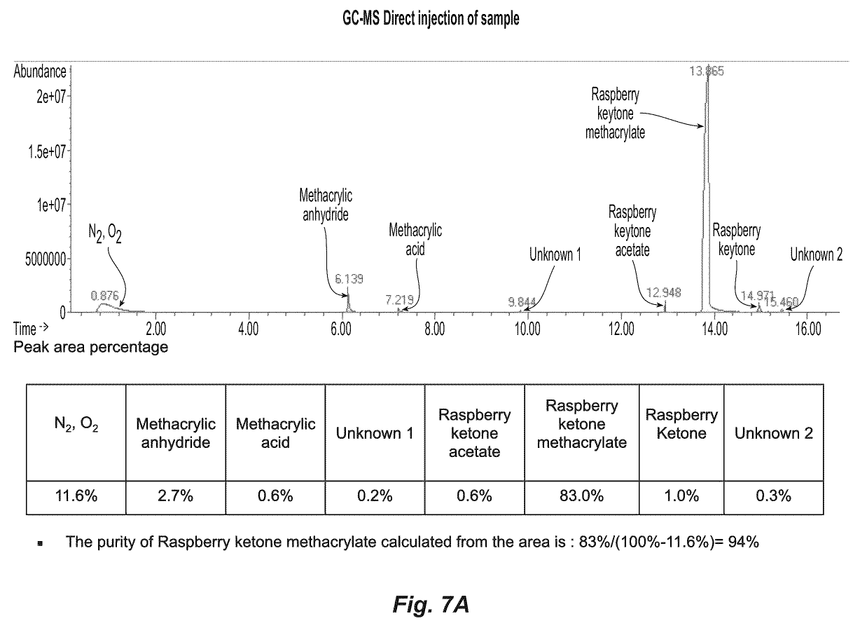

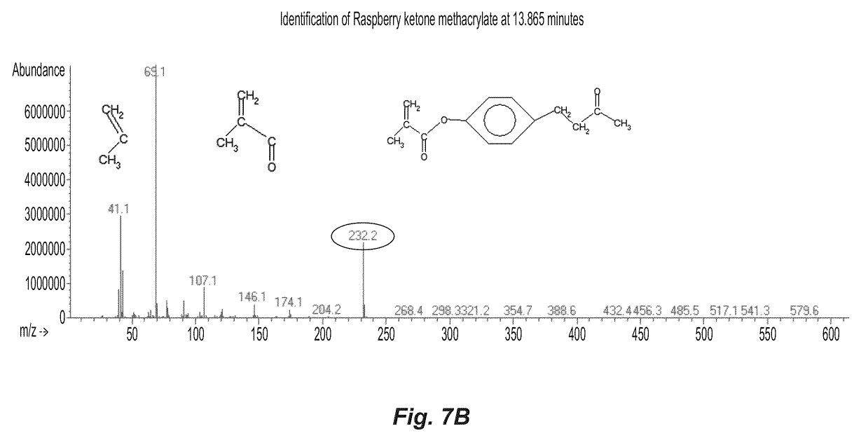

FIG. 7(a) shows the retention times of the various constituents of the gas sample that contains a strong signal at 13.865 minutes. The percentage of total abundance represents the percentage of the area of one peak over the total areas under all the peaks. Other minor components, e.g., less than 3%, include the original reactants (methacrylic anhydride at 6.131 minutes and raspberry ketone at 14.965 minutes) and even smaller amounts, e.g., less than 1%, of raspberry ketone acetate at 12.942 minutes and methacrylic acid at 6.139 minutes. A peak at 0.876 minutes of a constituent is believed to oxygen and nitrogen, as discussed below, which are the main components of air. The present inventors believe that this peak was caused by air introduced into the test. The abundance of peak at 13.865 minutes represents about 94% of the total abundance of all the constituents of the samples, when the oxygen and nitrogen peak is discounted.

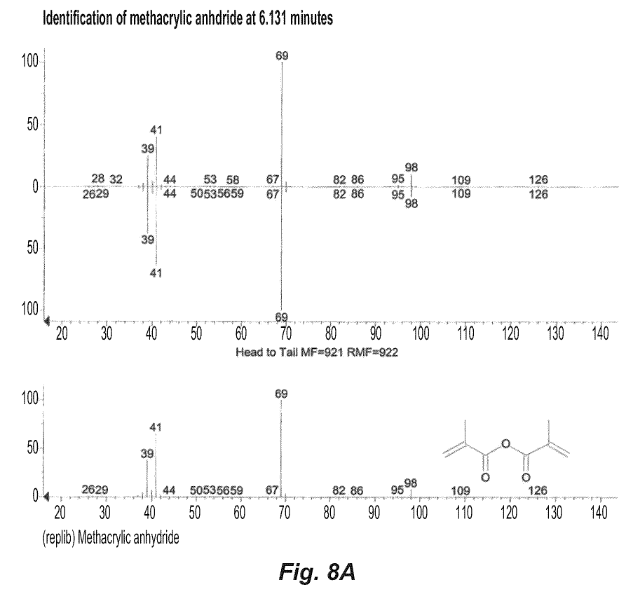

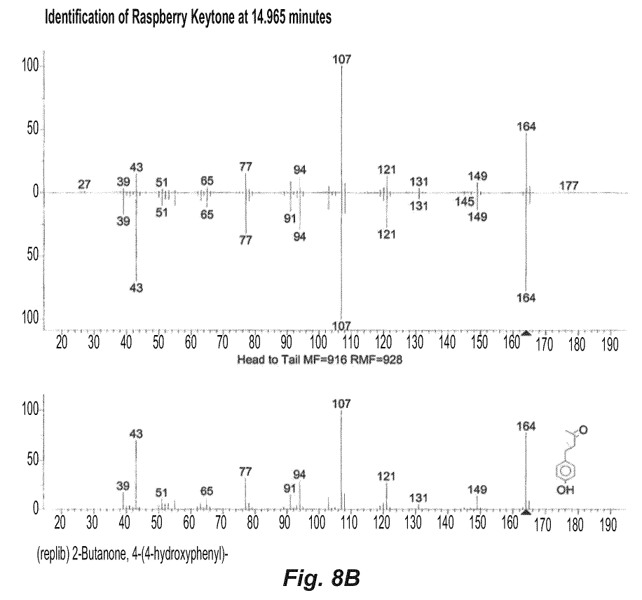

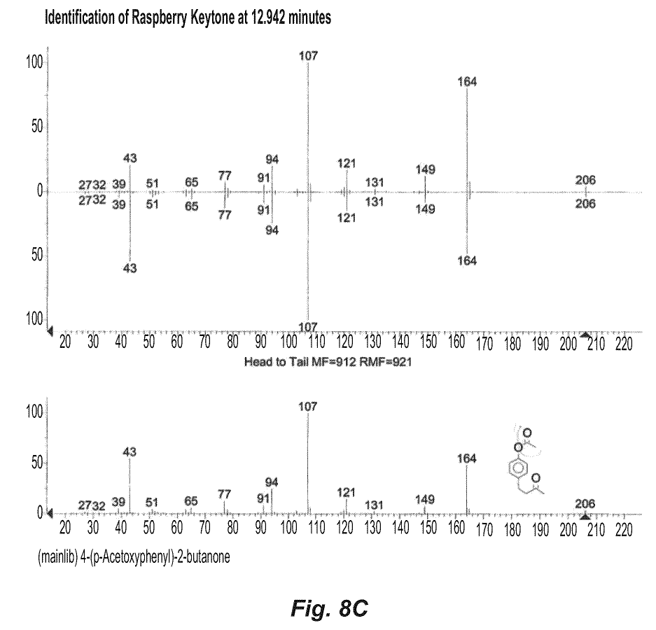

FIG. 7(b) shows the mass spectrum of the GC peak at 13.865 minutes; here, the molecular ion peak at 232.2 corresponds with the molecular weight of frambinone methacrylate, and the fragmentation pattern shows peaks at 69.1 and 41.1, which are indicative of the methacrylate portion of the molecule. The mass spectra for the GC peaks at 6.139, 14.971, and 12.948 minutes in FIG. 7(a) are shown in FIGS. 8(a)-(c) and found to be consistent with reference spectra for methacrylate anhydride, raspberry ketone and raspberry ketone acetate, respectively. The mass spectrum for methacrylic anhydride in FIG. 8(a) matches the standard mass spectrum for same as published in the PubChem.ncbi.nlm.nih.com website with peaks at 39, 41 and 69 on the m/z axis. The mass spectrum for raspberry ketone shown FIG. 8(b) matches the standard mass spectrum for that compound from the same source with peaks at 43, 77, 94, 107 and 164 on the m/z axis. The mass spectrum for raspberry ketone acetate in FIG. 8(c) is similar to the mass spectrum for raspberry ketone shown in FIG. 8(b) with the same peaks, since these two compounds are structurally similar, and has an additional small peak at 206, which is indicative for the molecular ion. The mass spectrum for nitrogen and oxygen from the same PubChem source has peaks at 28 and 32, respectively, and the mass spectrum for methacrylic acid has peaks at 39, 40.5 and 86 on the m/z axis. None of these compounds has a strong peak above 164 on the m/z axis.

Referring back to FIG. 7(b), the strong peaks at m/z at 41.1 and 69.1 are associated with predominantly the methacrylic acid portion of frambinone methacrylate, and with the methacrylic anhydride impurity or fragments thereof. The peaks at 43 and 107.1 are associated with predominantly the raspberry ketone portion of frambinone methacrylate, and with raspberry ketone and raspberry ketone acetate impurities. The peak at m/z=232.2 at 13.865 minutes represents the molecular ion of the novel frambinone methacrylate monomer.

The TLC test (FIG. 1), the NMR spectroscopy (FIGS. 2-3), the FTIR spectroscopy (FIGS. 4-6) and the GC-MS test (FIGS. 7-8 and subparts) confirm that a novel monomer, frambinone methacrylate, was synthesized.

### Example 2. Homo-Polymerization of Frambinone Methacrylate

The novel frambinone methacrylate monomer was polymerized utilizing the solution polymerization technique. Frambinone methacrylate and a 1 wt. % initiator solution of azobisisobutyronitrile (AIBN) were admixed in tertiary butanol solvent. The mixture was sealed and stored at 65° C. for 48 hours. Thereafter, the solid that had formed was isolated, washed with isopropyl alcohol (IPA), and dried in a forced air oven at 65° C. The homopolymer was isolated as a white solid at RT, and ground to a white powder.

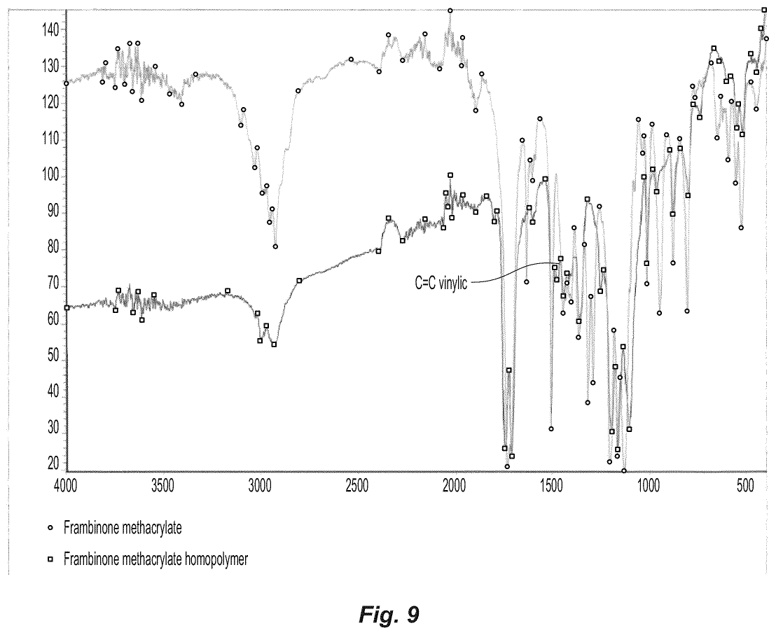

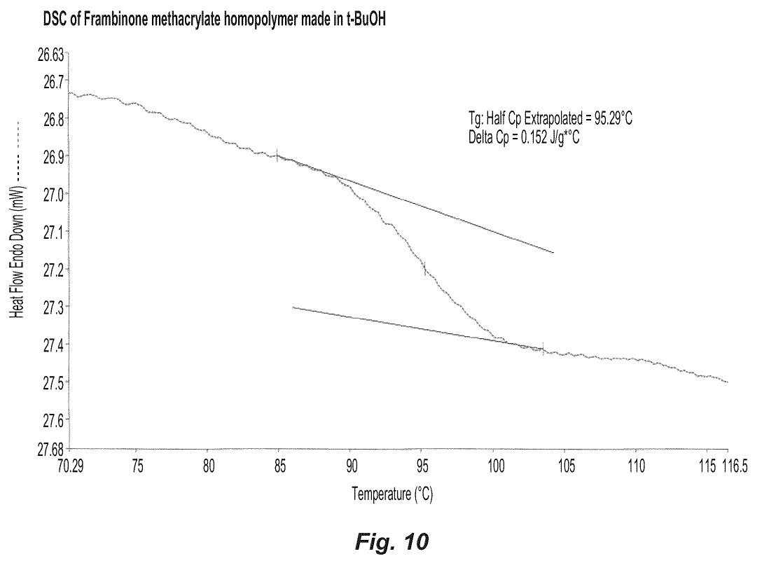

FIG. 9 shows a FTIR graph of the frambinone methacrylate monomer substantially on top of a FTIR graph of the homopolymer of this monomer. The sharp dip at 1638 cm⁻¹, indicating the C═C vinylic moiety in the frambinone methacrylate monomer, is not present in the spectrum of the homopolymer, which is expected in homopolymer formation. The Tg of the frambinone methacrylate homopolymer was measured using the experimental differential scanning calorimetry (DSC) technique, and found to be 95° C., as shown in FIG. 10.

### Example 3. Copolymerization Including Frambinone Methacrylate

Frambinone methacrylate was copolymerized with methyl methacrylate (MMA), butyl methacrylate (BA) and methacrylic acid (MAA) utilizing the emulsion polymerization technique. Frambinone methacrylate was utilized without further purification, except for the removal of the dichloromethane (CH₂Cl₂) solvent. Into a 1-liter, four-neck round bottom flask equipped with a thermocouple, feed tube, nitrogen inlet and a reflux condenser, water, surfactant and a sodium bicarbonate buffer were charged. An aqueous emulsion of MMA, BA, MAA (1 wt. % based on total monomer solids or BOTMS), a wet adhesion monomer (1 wt. % BOTMS) and frambinone methacrylate (5 wt. % BOTMS) was prepared. About 5 wt. % of the monomer emulsion was fed into the round bottom flask and the polymerization was started by an addition of a sodium persulfate initiator at about 80° C. After 15 minutes of stirring, more monomer emulsion was fed to the mixture and after 30 minutes the feed rate was increased. After 3 hours, all of the monomer emulsion was added to the mixture. The mixture was held at about 80° C. for 30 minutes, then cooled to about 60° C. The mixture was chased by adding in a dropwise fashion over 15 minutes with an oxidizer solution of tertiary butyl hydroperoxide (tBHP) and a reducer solution of sodium salt of an organic sulfinic acid derivative. The mixture was then cooled to about 35° C. and neutralized with a 3.5 wt. % solution sodium hydroxide (NaOH). The mixture was further cooled, and biocide was added.

The inventive copolymer has the following properties:
pH=9.1
% solid=48.9%
Particle size=146.8 nm (volume average),
MFFT=3.4° C. per ISO 2115 (April 2001) for measuring minimum film forming temperature
Brookfield viscosity=110 cP

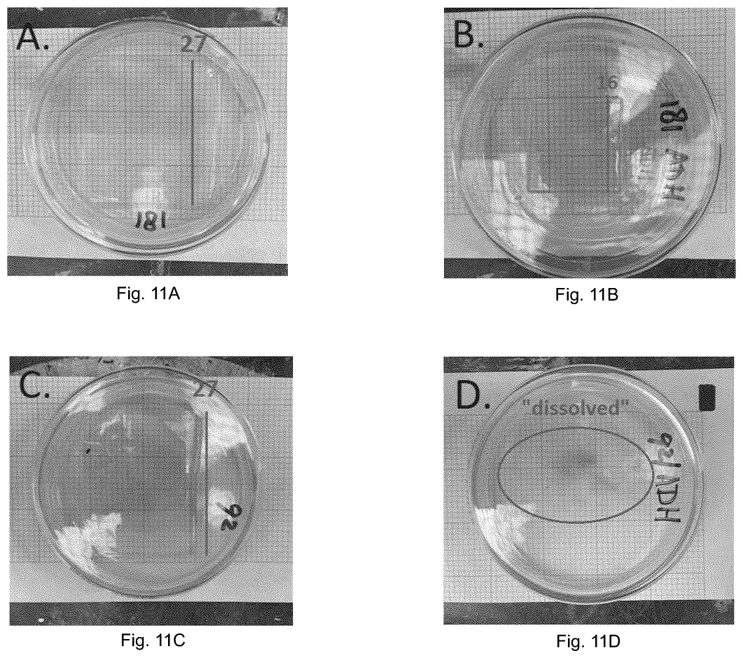

The Swell-Ratio Test. The inventive copolymer from Example 3 was tested and compared to a comparative, similar copolymer without frambinone methacrylate. Both comparative sample and inventive Example 3 with and without ADH crosslinking agent in the aqueous phase were drawn on a clear substrate and allowed to evaporate and coalesce. As arranged in FIG. 11, sample A is Example 3 without ADH; sample B is Example 3 with ADH; sample C is a comparative copolymer without ADH, and sample D is the comparative copolymer with ADH.

In this test, resin films were drawn to a 20 mil (20 thousandth of 1-inch) thickness with a wet drawdown bar on glass sheets. The films were dried at constant humidity and constant temperature (RH of 70% and at RT). The dried films were released and cut into desired sample squares. The cut samples were developed in closed petri dishes in methyl ethyl ketone/toluene at 1:1 ratio solvent mixture for 2 hours. The size of the gel samples was measured on graph papers. 10 units are equaled to 25 mm (1 inch); 8 units are equaled to 20 mm. The swelling is isotropic, i.e., the sample length and width swelled to the same extent. A reduced swelling of a sample is an indication of cross-linking.

Squares of 8×8 units on each side were cut from the dried films. Inventive sample A without ADH and comparative samples C and D were not expected to cross-link, and after the immersion in the MEK/toluene solvent samples A and C had expanded or swelled to squares of 27×27 units. Sample D was partially dissolved. In contrast, inventive sample B with the crosslinking agent ADH had only expanded or swelled to a square of 16×16 units. The ratio of swelling is 16²:27² or 256:729 or 1:2.85, which indicates that the inventive co-polymer self-cross-linked to each other via ADH forming a stronger film that was capable of resisting swelling by the solvents. The amount of cross-linking can be ascertained from the swell ratio by applying ASTM D2765 or ASTM F2214.

It is noted that Example 3 was neutralized with NaOH after polymerization as discussed above, but was still able to resist swelling indicating significant cross-linking, which is surprising, since it is known that ketone-hydrazide crosslinking is promoted by a pH change into the acidic region.

As shown by the above disclosures, a new monomer frambinone methacrylate (FMA) or raspberry ketone methacrylate (RKMA) was synthesized. A homopolymer of FMA or RKMA has an experimental Tg via DSC of about 95° C. FMA or RKMA when copolymerized with other monomers to form a latex copolymer resin capable of forming a paint/stain film that can self-crosslink with a hydrazine.

In another embodiment, zingerone is utilized as a starting material. Zingerone is a ketone derived from the ginger plant, and is generally produced from gingerols, a volatile oil, during the drying process. Zingerone is also known as vanillyl acetone, 4-(4-hydoxy-3-methoxyphenyl)-2-butanone, or 4-(4-hydroxy-3-methoxyphenyl) butan-2-one or 4-phenylbutan-2-one. Structurally, zingerone is similar to raspberry ketone, described above, except that it has a methoxy group (—OCH₃) attached to the phenyl ring, as shown below.

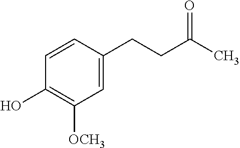

Similar to raspberry ketone, the hydroxy (OH) moiety in zingerone reacts with another compound or a monomer to be synthesized into another novel monomer. A preferred compound or monomer is methacrylic anhydride, which is a reactive monomer that can be used to prepare other monomers and is described above.

### Example 4. Bi-Phasic Reaction Between Zingerone and Methacrylic Anhydride

A new zingerone methacrylate monomer was synthesized from zingerone and methacrylic anhydride from a bi-phasic reaction between zingerone and methacrylic anhydride, similar to Example 1 with zingerone replacing raspberry ketone, except that more solvent was used. Zingerone methacrylate has a higher tendency to precipitate due to the methoxy substituent on the phenyl ring, which increases the crystallinity of the monomer. To a solution of zingerone and methacrylic anhydride in dichloromethane (CH₂Cl₂) solvent was added an aqueous 10 wt. % solution of sodium hydroxide (NaOH). The mixture was stirred for about 1 hour at room temperature (RT or about 77° F.). The organic phase was isolated and washed with deionized (DI) water. The organic phase was isolated and concentrated to yield zingerone methacrylate as an off-white, crystalline solid. Zingerone methacrylate has the following structure:

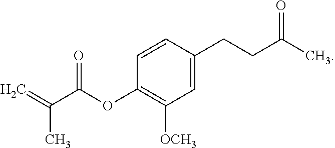 [SMILES: C=C(C)C(=O)Oc1ccc(CCC(C)=O)cc1OC]

As shown, the zingerone's hydroxy reaction site was utilized to react and bond to an acyl moiety of the methacrylic anhydride. In this Example, 1 mole of methacrylic anhydride was used to react with 1 mole of zingerone. Other than the resulting zingerone methacrylate monomer, the other compounds remaining in the mixture include traces of the residual starting materials, zingerone and methacrylic anhydride.

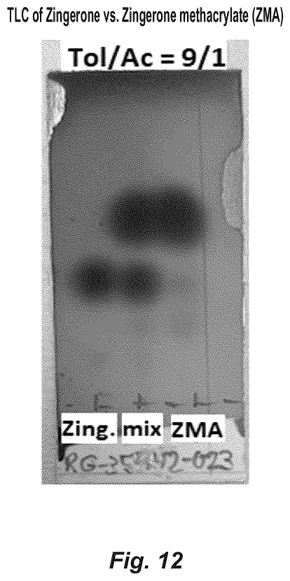

Thin Layer Chromatograph (TLC). Samples of a mixture containing both zingerone methacrylate and zingerone, only zingerone methacrylate, and only zingerone, were spotted or deposited proximate to a bottom end of a support substrate, e.g., aluminum or glass, covered by a stationary phase, which typically is silica gel. As best shown in FIG. 12, a zingerone spot is deposited on the left-hand side, and a zingerone methacrylate, labeled as “ZMA,” is deposited on the right-hand side. A spot that contains a mixture of both is deposited in between. The support substrate was turned vertically with the spots proximate the bottom and then the spots were eluted, i.e., to remove or move an adsorbed substance upward by washing with a solvent mixture, which comprises about 90% toluene and about 10% acetone. FIG. 12 shows that the zingerone spot moved a first short distance upward and the zingerone methacrylate spot moved a second longer distance upward. Instructively, the spot of the mixture separated into two spots: one at the first distance of the zingerone and another at the second distance of the zingerone methacrylate. The R_{f} for zingerone methacrylate in FIG. 12 is about 0.58 and the R_{f} value of the zingerone is about 0.36. The TLC test shows that zingerone methacrylate is different than or at least has a different polarity (is more hydrophobic) than the starting material zingerone.

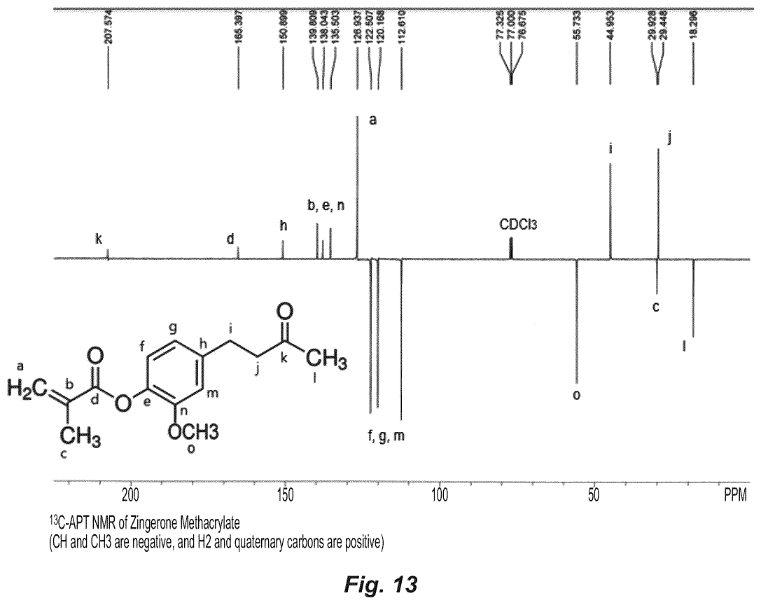

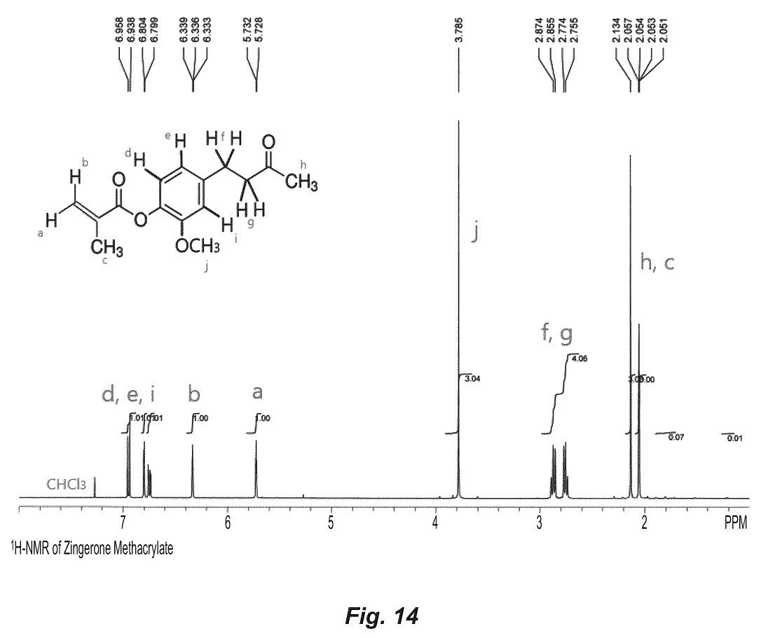

NMR spectroscopy analysis was also conducted for zingerone methacrylate. Zingerone methacrylate structure with the carbon labeled from “a” to “1”, and with the hydrogen labeled from “a” to “h”, respectively are shown below. FIG. 13 shows the ¹³C-NMR spectrum and FIG. 14 shows the ¹H-NMR spectrum for zingerone methacrylate. The NMR instruments for FIGS. 13-14 are rated at 400 MHz.

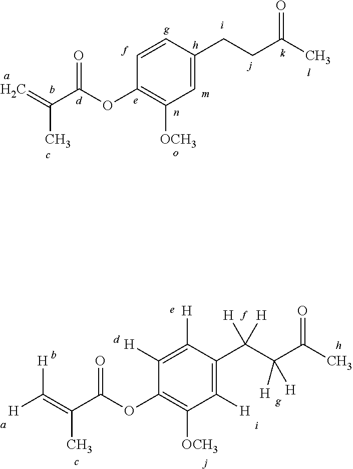 [SMILES: C=C(C)C(=O)Oc1ccc(CCC(C)=O)cc1OC ; C=C(C)C(=O)Oc1ccc(CCC(C)=O)cc1OC]

FIG. 13 shows the peaks for the carbon nuclei “a”-“1” as well as the characteristic triple peak for CDCl₃ at about 77 ppm. ¹³C-NMR data (CDCl₃ 400 MHz): δ 207.6 (k), 165.4 (d), 150.9 (h), 139.8, 138.0 and 135.5 (b, e and n), 126.9 (a), 122.5, 120.2 and 112.6 (f, g and m), 77.3, 77.0, and 76.7 (CDCl₃), 55.7 (o), 45.0 (i), 29.9 (c), 29.4 (j), and 18.3 (l).

FIG. 14 shows the peaks for the proton/hydrogen nuclei “a” to “h” with a small peak for the chloroform present in CDCl₃ at about 7.3 ppm. ¹H NMR data (CDCl₃, 400 MHz): δ 7.27 (CHCl₃), 6.94 (doublet, CH phenyl, d, J_{d,e} 8.0 Hz), 6.80 (doublet, CH phenyl, i, J_{i,e} 2.0 Hz,), 6.75 (double doublet, CH phenyl, e, J_{e,d} 8.0 Hz, J_{e,i} 2.0 Hz), 6.34 (multiplet, CH vinyl, b), 5.73 (multiplet, CH vinyl, a), 3.79 (singlet, OCH₃, j), 2.87 (triplet, CH₂, f/g, J_{f,g} ca. 7.2 Hz), 2.76 (triplet, CH₂, f/g, J_{f,g} ca. 7.2 Hz), 2.13 (singlet, CH₃, h), 2.05 (multiplet, CH₃, c). NMR spectral data shows that the synthesis of zingerone methacrylate was successful.

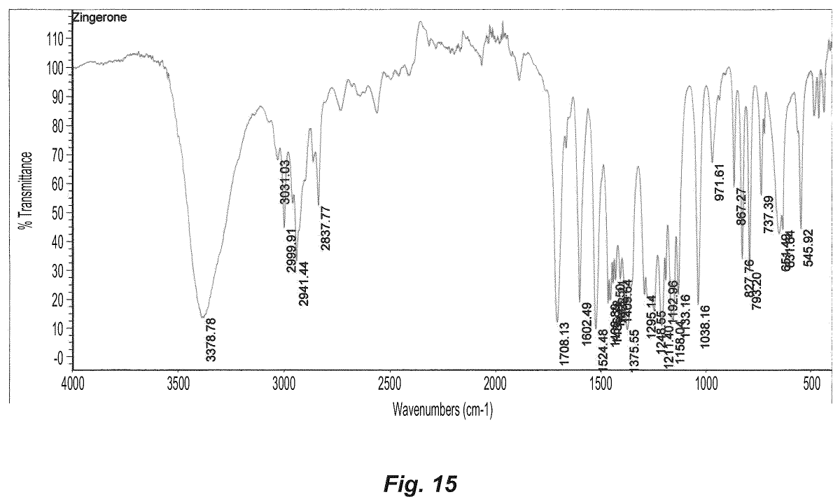

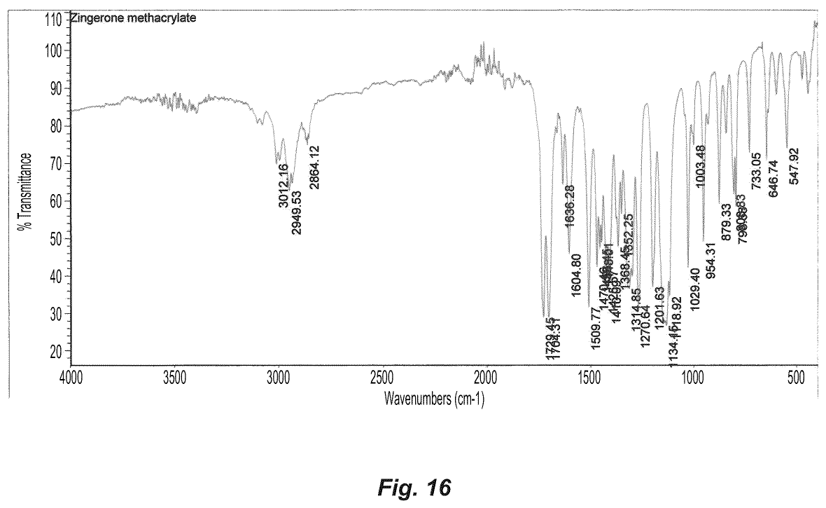

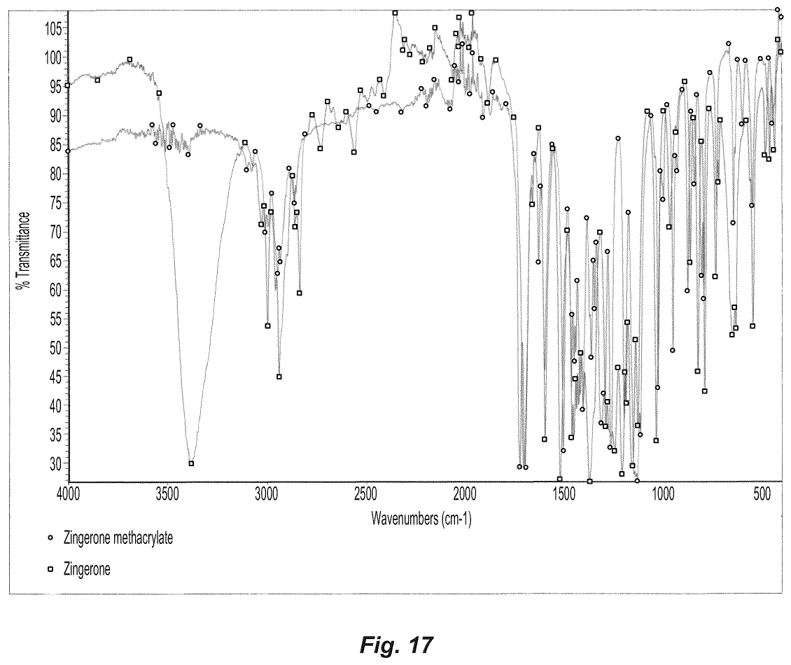

FIG. 15 is a FTIR spectrum of zingerone showing the various moieties at their respective frequencies. Of notes are the dip at 3379 cm⁻¹, which represents the phenol-hydroxy segment, and the ketone segment at 1708 cm⁻¹. FIG. 16 is a FTIR spectrum of the inventive zingerone methacrylate and FIG. 17 is a superposition of both spectra from FIGS. 15 and 16 with the spectrum for zingerone methacrylate substantially on top of the spectrum for zingerone. Figure xx shows the disappearance of the phenol-hydroxy moiety in the zingerone methacrylate monomer, which confirms that the hydroxy reaction site was used in the reaction. The ester ketone spike was shifted slightly to 1704 cm⁻¹ and the occurrence of the methacrylate carbonyl at 1729 cm⁻¹ and C═C vinyl at 1636 cm⁻¹ are indicative of the synthesis of a new composition. FTIR data (in cm⁻¹): 3200-2850 (broad, multiple peaks), 1729, 1704, 1636 (weak), 1605, 1510, 1470, 1448, 1427, 1410, 1368, 1352, 1315, 1271, 1202, 1334, 1119, 1029, 1003 (weak), 954, 879, 804, 797, 733, 647, 548).

### Example 5. Homo-Polymerization of Zingerone Methacrylate

The homo-polymer of zingerone methacrylate was prepared in a similar manner as the homo-polymer of frambinone methacrylate from Example 2.

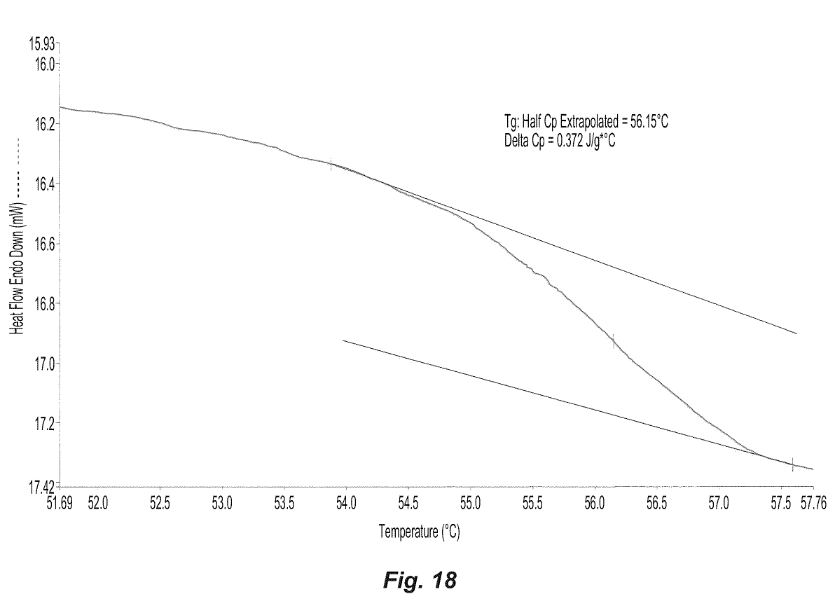

The Tg of the zingerone methacrylate homopolymer was measured using the experimental differential scanning calorimetry (DSC) technique, and found to be about 56° C., as shown in FIG. 18.

### Example 6. Copolymerization Including Zingerone Methacrylate

Zingerone methacrylate was copolymerized with methyl methacrylate (MMA), butyl acrylate (BA) and methacrylic acid (MAA) utilizing the emulsion polymerization technique. Zingerone methacrylate was utilized without further purification, except for the removal of dichloromethane (CH₂Cl₂) solvent. Into a 1-liter, four-neck round bottom flask equipped with a thermocouple, feed tube, nitrogen inlet and a reflux condenser, water, surfactant, and a sodium bicarbonate buffer were charged. An aqueous emulsion of MMA, BA, MAA (1 wt. % based on total monomer solids or BOTMS), a wet adhesion monomer (1 wt. % BOTMS) and zingerone methacrylate (5 wt. % BOTMS) was prepared. About 5 wt. % of the monomer emulsion was fed into the round bottom flask and the polymerization was started by an addition of a sodium persulfate initiator at about 80° C. After 15 minutes of stirring, more monomer emulsion was fed to the mixture and after 30 minutes the feed rate was increased. After 3 hours, all of the monomer emulsion was added to the mixture. The mixture was held at about 80° C. for 30 minutes, then cooled to about 60° C. The mixture was chased by adding in a dropwise fashion over 15 minutes with an oxidizer solution of tertiary butyl hydroperoxide (tBHP) and a reducer solution of sodium salt of an organic sulfinic acid derivative. The mixture was then cooled to about 35° C. and neutralized with a 3.5 wt. % solution sodium hydroxide (NaOH). The mixture was further cooled, and biocide was added.

The inventive copolymer has the following properties:
pH=8.4
% solid=49.5%
Particle size=140 nm (volume average),
MFFT=3° C. per ISO 2115 (April 2001) for measuring minimum film forming temperature, and
Brookfield viscosity=90 cP

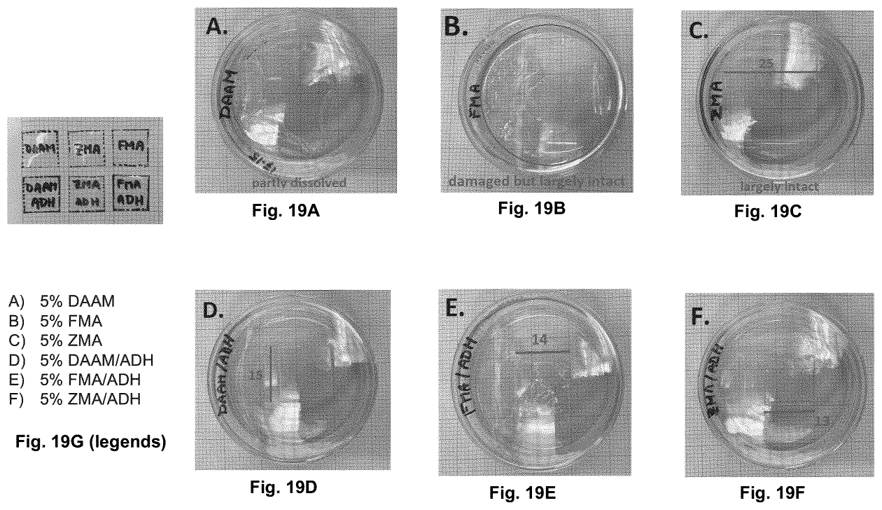

The Swell-Ratio Test. The inventive copolymer with zingerone methacrylate from Example 6 was tested and compared to a similar copolymer with frambinone methacrylate similar to that of Example 3 and a comparative, similar copolymer with the reactive diacetone acrylamide (DAAM) monomer. These three polymer samples were tested with and without ADH. Samples were prepared in the same manner as described above. FIGS. 19(A)-(F) are photographs of dry film samples of 8×8 units developed in MEK/toluene solvent for 2 hours and swelled. FIGS. 19(A) and (D) are samples with 5 wt. % of DAAM. The sample without ADH was partially dissolved and the sample with ADH swelled to 15×15 units² (3.5× swelling). FIGS. 19(B) and (E) are samples with 5 wt. % FMA. The sample without ADH was partially damaged but remained intact and the sample with ADH swelled to 14×14 units² (3.1× swelling). FIGS. 19(C) and (F) are samples with 5 wt. % ZMA. The sample without ADH remained intact and swelled to 25×25 units² (9.8× swelling), and the sample with ADH swelled to 13×13 units² (2.6× swelling). As stated above, the amount of cross-linking can be ascertained from the swell ratio by applying ASTM D2765 or ASTM F2214.

Paints with acrylic co-polymer resins with FMA, without FMA and with a conventional cross-linkable monomer DAAM were made and compared to each other, as shown in the following experiments.

Inventive Example 7: Acrylic Latex Co-Polymer Made with Frambinone Methacrylate Monomers. The components for forming an acrylic latex polymer with self-crosslinkable FMA are provided below. To produce the binder, the reactor seeding was added into a nitrogen purged 4-neck reactor followed by a temperature increase to 75-80° C. Next, 50 g of the premixed monomer emulsion was added to the reactor followed by initiator solution I. The mixture was then allowed to react for 15 minutes. The remaining monomer emulsion and initiator solution II were then simultaneously added to the reactor over a period of 3.5 hours. The latex formed in the reactor was kept at 80° C. for 1 hour. The reactor was cooled to 60° C. followed by the simultaneous addition of the oxidizing agent and reducing agent solutions over a period of 30 minutes. The reactor was cooled to room temperature (e.g., 25° C.) and the biocide solution was added to arrive at a latex binder with a Flory-Fox glass transition temperature of 16° C. and a solid content of 51.2%. The latex is free of grits and has a particle size of 128 nanometers (volume average).

| | |
|---|---|
| Component | Amount (g) |

Reactor Seeding

| | |
|---|---|
| Water | 409 |
| Alpha-olefin surfonate (40%) | 1.5 |
| Sodium bicarbonate | 1 |

Monomer Emulsion

| | |
|---|---|
| Water | 376 |
| Alpha-olefin surfonate (40%) | 13.5 |
| Phosphate ester surfactant (25%) | 39 |
| Ureido methacrylate (50%) | 21.2 |
| Methacrylic acid | 11 |
| Methyl methacrylate | 482 |
| Butyl acrylate | 424.4 |
| Frambinone methacrylate | 5.6 |
| Ammonium hydroxide (26%) | 1.5 |

Initiator Solution I

| | |
|---|---|
| Water | 10.4 |
| Sodium persulfate | 1.82 |

Initiator Solution II

| | |
|---|---|
| Water | 16.1 |
| Sodium persulfate | 0.73 |

Oxidizing Agent Solution

| | |
|---|---|
| Tert-butylperoxide (70%) | 1.55 |
| Water | 17.5 |

Reducing Agent Solution

| | |
|---|---|
| BRUGGOLITE FF6 M | 1.55 |
| water | 17.5 |

Biocide Solution

| | |
|---|---|
| ACTICIDE CBM 2 | 3.8 |
| Water | 8.1 |
| Total | 1859.4 |

### Comparative Example 8: Acrylic Latex Co-Polymer Made without Self-Crosslinking

Monomer. This comparative polymer example was made with the same components and process as inventive example 7, except that FMA was omitted from the monomer emulsion. The latex polymer has a similar Flory-Fox glass transition temperature of 16° C. and a solids content of 51.1%. The latex is free of grits and has a particle size of 116 nanometers (volume average).

### Comparative Example 9: Acrylic Latex Polymer Made with Diacetone Acrylamide

(DAAM) Monomer. This comparative polymer example was made with the same components and process as in inventive example 7, except that 5.6 grams (equivalent to 0.024 moles) of FMA was replaced by 4 grams (equivalent to 0.024 moles) of DAAM in the monomer emulsion. By having same moles for both crosslinking monomers, the number of crosslinking functional groups, e.g., the ketone groups, will remain same in both latex polymers.

The comparative polymer example 9 has a similar Flory-Fox glass transition temperature of 16° C. and a solids content of 51.2%. The latex is free of grits and has a particle size of 133 nanometers (volume average).

Using the binder of latex polymers from Examples 7, 8, and 9, paint compositions were produced. The components for the paint compositions are provided below. While agitated at high speeds, the grind components were mixed for 10 minutes after all grind components were added. The agitation was slowed to mixing speed and the phase 1 letdown components were added and mixed for 20 minutes. The phase 2 letdown components were then added followed by additional mixing.

| | | | |
|---|---|---|---|
| Component (grams) | Example 7 | Example 8 | Example 9 |

Grind:

| | | | |
|---|---|---|---|
| water | 42.4 (g) | 42.4 (g) | 42.4 (g) |
| NUOSEPT 498 preservative | 0.5 | 0.5 | 0.5 |
| ACTICIDE RS | 1.2 | 1.2 | 1.2 |
| ZINC OMADINE ZOE | 1.2 | 1.2 | 1.2 |
| DISPERSION MILDEWCIDE | | | |
| Acrylic copolymer dispersant | 5.0 | 5.0 | 5.0 |
| (22%) | | | |
| Non-ionic surfactant | 1.5 | 1.5 | 1.5 |
| Defoamer 1 | 0.5 | 0.5 | 0.5 |
| TIONA 826 (Titanium Dioxide) | 132 | 132 | 132 |
| Kaolin extender pigment 1 | 10 | 10 | 10 |
| Kaolin extender pigment 2 | 6 | 6 | 6 |
| (calcined) | | | |

Letdown:
Phase 1

| | | | |
|---|---|---|---|
| AEPD VOX 1000 amino alcohol | 6 | 6 | 6 |
| Phosphate ester surfactant (25%) | 3 | 3 | 3 |
| Ropaque OP-96 (opaque polymer) | 7.5 | 7.5 | 7.5 |
| Rheology Modifier | 8.5 | 8.5 | 8.5 |
| (HUER type for Stormer viscosity) | | | |
| Low VOC coalescence aid | 1.5 | 1.5 | 1.5 |
| Eastman Texanol ester alcohol | 4 | 4 | 4 |
| glycol ether DPM | 3.5 | 3.5 | 3.5 |
| Adipic acid dihydrazide acetone | 15 | 0 | 15 |
| capped (40%) | | | |

Phase 2

| | | | |
|---|---|---|---|
| Inventive latex polymer Example 7 | 220 | | |
| (with FMA) | | | |
| Comparative latex polymer | | 220 | |
| Example 8 (without crosslinking | | | |
| monomer) | | | |
| Comparative latex polymer | | | 220 |
| Example 9 (with DAAM) | | | |
| Defoamer 2 | 3 | 3 | 3 |
| Rheology Modifier | 9.0 | 9.0 | 9.0 |
| (Polyether type for ICI viscosity) | | | |
| Rheology Modifier | 3.0 | 3.0 | 3.0 |
| (HUER type for Stormer viscosity) | | | |
| Acrylic copolymer additive | 20 | 20 | 20 |
| Water | 40 | 40 | 40 |

### Results and Discussion of Example 7-9

Paints were tested for stain cleansability, block resistance, tackiness, and scrubbability.

| | Cleanability (7 day dry) Delta E | | | | | Tackiness (CT3) | | Block resistance | | Scrubs |
|---|---|---|---|---|---|---|---|---|---|---|
| Paints | Graphite | Ketchup | Mustard | Wine | Coffee | 1 day dry | 7 day dry | 1 day dry | 7 day dry | (7 day dry) |
| Inventive | 2.68 | 0.23 | 0.38 | 3 | 1.82 | 1 | 3 | 2 | 2 | 1039 |
| Example 7 | | | | | | | | | | |
| Comparative | 0.08 | 0.09 | 0.29 | 1.25 | 1.25 | 60 | 69 | 1(20%) | 1(10%) | 829 |
| Example 8 | | | | | | | | | | |
| Comparative | 4.42 | 0.12 | 0.14 | 3.99 | 1.75 | 20 | 2 | 2 | 3 | 1689 |
| Example 9 | | | | | | | | | | |

Inventive paint Example 7 has improved tack and block resistance, and scrubbability over comparative example 8, which does not have a crosslinking monomer. The present inventors believe that these improved properties were the effects of crosslinking of acrylic monomers with FMA in inventive paint Example 7.

Inventive paint Example 7 also has improved tack and block resistance, and equal or better stain cleanability, particularly for wine and graphite to comparative example 9, which has DAAM.

Inventive paint Example 7 has better scrubbability than comparative example 8, which has no crosslinking monomer in the resin. Comparative example 9 has higher scrubbability than the inventive paint example 7.

Preferably, based on the swell-ratio tests of Example 6 and on Example 7, FMA or ZMA or bio-based monomers with a ketone reactive site is present in the resin copolymer from about 0.25 wt. % to about 10 wt. %, preferably from about 0.40 wt. % to about 8 wt. %, and more preferably about 0.5 wt. % to about 6 wt. %. More preferred weight percentage ranges based on experiments conducted with latex resin compositions and/or paint/architectural compositions are discussed below.

The results show that when compared to the conventional DAAM/ADH cross-linkable mechanism, both FMA/ADH and ZMA/ADH show a high film integrity through cross-linking.

### ALTERNATIVE EMBODIMENTS

The present invention is not limited to the embodiments described above. Other starting materials can replace either the ketone compound, or methacrylic anhydride, or both.

Methacrylic anhydride belongs to the group of acid anhydrides. An acid anhydride is a compound that has two acyl groups bonded to the same oxygen atom. An acid anhydride has the following general structure,

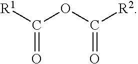

Other suitable acid anhydrides are vinylic structures which contain unsaturated alkene chemistry, and which include but are not limited to acrylic anhydride, maleic anhydride and other unsaturated acid anhydrides.

Another suitable compound that may be substituted for methacrylic anhydride is glycidyl methacrylate, having the following structure,

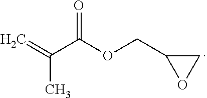

Synthesis by etherification involving glycidyl methacrylate is discussed in Al-Odayni, A.-B. et al., New Monomer Based on Eugenol Methacrylate, Synthesis, Polymerization and Copolymerization with Methyl Methacrylate—Characterization and Thermal Properties, Polymers 2020, 12, 160, 1-20; doi:10.3390/polym12010160, which is incorporated herein in its entirety.

Other phenolic compounds with a ketone reaction site and a hydroxy reaction site can be used in place of raspberry ketone or zingerone. Piceol is another suitable compound, which can be found in the needles and in mycorrhizal roots of Norway spruces. Piceol methacrylate can also be synthesized using the same technique.

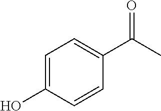

4-hydroxyphenylacetone is another suitable phenolic compound with a ketone reaction site and a hydroxy reaction site.

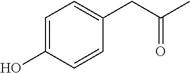

Other suitable bio-based phenolic compounds that can be synthesized into monomers and polymers are discussed in Lochab, B. et al., Naturally occurring phenolic sources: monomers and polymers, RSC Adv. 2014, 4, 21712-21752, which is incorporated by reference in its entirety.

### Alternative Synthesizing Techniques

Generally, (meth)acrylic monomers, including FMA and ZMA, can be made either directly from (meth)acrylic acid in an esterification reaction, or from an activated form of (meth)acrylic acid, which can be an anhydride, acyl chloride, N-hydroxysuccinimide ester, etc. FMA and ZMA can be synthesized by other means, i.e., other than the technique discussed in Example 1.

FMA and ZMA can be synthesized by a Fisher, or Fisher-Speier esterification, between (meth)acrylic acid (or short alkyl chain ester thereof, such as the methyl- or ethyl ester), and raspberry ketone in the presence of a strong Lewis or Brønstedt acid catalyst. The reaction is performed preferably neat, but can also be performed in the presence of a solvent, which aids in the azeotropic removal of water (or methanol/ethanol), which is formed over the course of the reaction. Examples of Fisher type esterifications of phenol can be found in Batra, P. C., Rozdon, O. N., Acetylation of phenols using acetic acid, Proc. Indian Acad. Sci. (Math. Sci.) 1949, 29, 349-351; Offenhauer, R. D., The direct esterification of phenols, J. Chem. Ed. 1964, 41(1), 39; Konwar, D. et. al., Esterification of carboxylic acids by acid activated Kaolinite clay, Ind. J. Chem. Techn. 2008, 15, 75-78. These references are incorporated herein by reference in their entireties.

Alternatively, the methacrylic acid (or short alkyl chain ester thereof, such as the methyl- or ethyl ester) can be reacted in the presence of a lipase B enzyme, such as Novozym 435, as a catalyst. This reaction is preferably heated and can be performed neat/undiluted or in an organic solvent. Preferably, the organic solvent aids in the azeotropic removal of water (or methanol/ethanol) formed during the reaction. Examples of Lipase catalyzed synthesis are described in V. Athawale et al., Lipase-Catalyzed Synthesis of Geranyl Methacrylate by Transesterification: Study of Reaction Parameters Tetrahedron Letters 2020, 43(27), 4797-4800, and Roby, M. H. et al., Enzymatic Production of Bioactive Docohexaenoic Acid Phenolic Ester, Food Chemistry 2015, 171, 397-404. These references are incorporated herein by reference in their entireties.

Alternatively, FMA and ZMA can be made from an activated form of acid. For example, it can be made from a reaction between (meth)acrylic anhydride and raspberry ketone or zingerone in a variety of ways, as described by Anbu, N. et. al. in Acetylation of alcohols, amines, phenols, thiols under catalyst and solvent-free conditions, Chemistry 2019, 1, 69-79; Jin, T.-S. et al., Rapid and efficient method for acetylation of alcohols and phenols with acetic anhydride catalyzed by silica sulfate, Synthetic Communications 2006, 36, 1221-1227; Haddadin, M. J. et al., Acylation of phenol by cyclic and acyclic anhydrides in anhydrous acetic acid, J. Pharm. Sci. 1975, 64(11), 1766-1770; Yue, C. et. al., Acetylation of alcohols and phenols with acetic anhydride under solvent-free conditions using an ionic liquid based on morpholine as a recoverable and reusable catalyst, Monatshefte für Chemie—Chemical Monthly 2010, 141, 975-978; Meshram, G. A. and Patil, V. D., Simple and efficient method for acetylation of alcohols, phenols, amines, and thiols using anhydrous NiCl₂ under solvent-free conditions, Synth. Commun. 2009, 39(14), 2516-2528. These references are incorporated herein by reference in their entireties.

FMA and ZMA can also be synthesized by the methods described in US 2018/0201703 to Kessler et al. or US 2014/0275435 to Holmberg et al. to synthesize methacrylated vanillin and/or methacrylated vanillyl alcohol. Other syntheses are disclosed in Al-Odayni, A.-B. et al., New Monomer Based on Eugenol Methacrylate, Synthesis, Polymerization and Copolymerization with Methyl Methacrylate—Characterization and Thermal Properties, Polymers 2020, 12, 160, 1-20; Tale, N. V., Jagtap, R. N., Synthesis of Diacetone Acrylamide Monomer and the Film Properties of Its Copolymers, Iranian Polym. J. 2010, 19(10), 801-810; Rupavani, J. et al., Synthesis, Characterization and End Use Evaluation of 2-Allyl-3(5)-pentadecyl Phenol and Their Acrylic/Methacrylic Esters, Eur. Polym. J. 1993, 29(6), 863-869. All of these references are incorporated herein by reference in their entireties.

### Architectural Compositions Utilizing Copolymer Resins with Bio-Based Cross-Linking Monomers

In generalized terms, suitable self-crosslinking monomers, including the bio-based self-crosslinking monomers, described herein contain at least one ethyencly unsaturated hydrocarbon and a carbonyl or a ketone group. A generic crosslinking monomer is shown below. The unsaturated hydrocarbon and the carbonyl or ketone are connected by a spacer, which is an organic functional group.

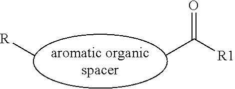

R is an ethylenically unsaturated hydrocarbon which has at least one reactive double bond, such as a vinyl, acrylic or methacrylic group. R1 can be a hydrogen (H) or has the following chemical structure:

R1=C(R′)(R″)(R′″)

R′, R″, R′″ are either H or organic functional groups.

The spacer contains at least one hydrophobic group, typically an aromatic functional group. The spacer can be a phenyl ring or can include a phenyl ring. In contrast to the bio-based monomers discussed herein, the DAAM monomer has a hydrophilic spacer. Examples of hydrophobic spacers with link to a carbonyl or ketone groups can be found in synthetical and natural products, such as 4-ydroxy-3-imethoxybenzaldehyde (vanillin), raspberry ketone, piceol, 4-hydroxylphenylacetone, zingerone, discussed above. Another suitable bio-based compound with a hydrophobic spacer is 4-hydroxy-3′-methoxyacetonephenone (acetovanillone or apocynin). Acetovanillone and vanillin have similar structures,

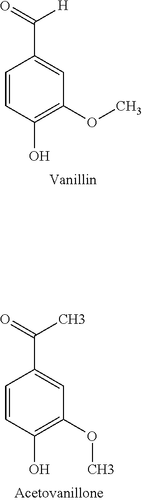

Vanillin and acetovanillone can be formed into methacrylates using a similar reaction, discussed above in connection with the formations of FMA and ZMA. Vanillin methacrylate (VALMA), which is referred as methacrylated vanillin (MV) in the Stanzione III reference or Kessler et al. reference, and acetovanillone methacrylate (AVMA) have the following structures,

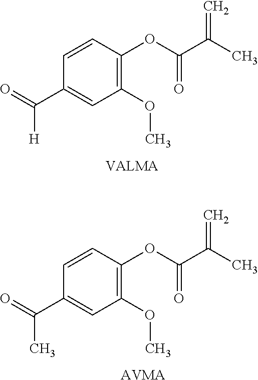

VALMA and AVMA can be generalized by the following generic structure,

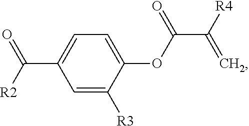

where R2 is H or CH₃; R3 is OCH₃; and R4 is CH₃. R2 represents the difference between VALMA and AVMA.

Additional copolymers that incorporated VALMA, AVMA and ZMA were prepared and tested, and additional experiments/tests for copolymers incorporating VALMA, AVMA, FMA and ZMA were conducted, as discussed below.

### Example 10. Preparation of Emulsion Copolymer with 4-Hydroxy-3-Methoxybenzaldehyde (VALMA)

The emulsion polymerization is carried out in a one-gallon size four-neck flask under nitrogen purge. The reaction flask is equipped with a condenser, a thermometer, an agitator and a feeding pump. The flask is immersed in a temperature-controlled water bath maintained at a constant temperature within about ±0.1° C. of the set point. The table below shows the ingredients used for the polymerization.

| | |
|---|---|
| COMPONENTS | Mass (grams) |

Initial Charge in Reactor

| | |
|---|---|
| Deionized water | 733.3 |
| Sodium alphaolefin sulfonate (40% active) | 1.8 |
| Sodium bicarbonate | 2.7 |

Monomer Mix

| | |
|---|---|
| Deionized water | 673.6 |
| Sodium alphaolefin sulfonate (40% active) | 24.1 |
| Ethoxylated phosphate ester (25% active) | 69.8 |
| Methacrylic acid | 19.7 |
| N-(2-Methacryloyloxyethyl) ethylene urea | 37.9 |
| (50% active) | |
| Butyl acrylate | 760.1 |
| Methyl methacrylate | 863.4 |
| Vanillin methacrylate | 46.8 |
| Ammonium hydroxide (28%) | 2.9 |

Initiator Solution 1

| | |
|---|---|
| Sodium persulfate | 3.3 |
| Deionized water | 18.6 |

Initiator Solution 2

| | |
|---|---|
| Sodium persulfate | 1.3 |
| Deionized water | 28.8 |

Chaser Solutions

| | |
|---|---|
| 1. Oxidizing agent - pre-mix | |
| t-butylperoxide | 2.8 |
| Deionized water | 31.3 |
| 2. Reducing agent - pre-mix | 2.8 |
| Bruggolite ® FF6M | 31.3 |
| Deionized water | |

Neutralizer Pre-mix

| | |
|---|---|
| Ammonium hydroxide (28%) | 13.4 |
| Deionized water | 9.8 |

Biocide - Pre-mix

| | |
|---|---|
| Acticide ® | 6.8 |
| Deionized water | 14.5 |
| Total | 3,400.8 |

The reaction starts with charging deionized water, sodium alphaolefin sulfonate, and non-ionic surfactant to the reaction flask. The rector was heated to 80° C. under agitation. 110 grams of the monomer mixer, which was premixed in a separate flask, were charged to the reaction flask. After mixing for 5 minutes, the initiator solution 1 was added to the reaction flask to start the seeding polymerization. 15 minutes later, the remaining monomer mix and initiator solution 2 were fed to the reaction flask over a period of 3.5 hours. The temperature of the reaction flask was maintained at 80° C. for one hour after feeding was complete. It was then cooled to about 60° C. Chaser solutions made from oxidizing agent and reducing agent were fed to the reaction flask over a period of 30 minutes. The reaction contents were then cooled to 35° C. and ammonia hydroxide solution was added.

The final polymer emulsion has a solid content of 51.0% by weight. The dried polymer has a Tg of 9.9° C. from Fox Equation. The vanillin methacrylate in Example 10 is about 2.6% by weight based on total solids and about 0.012% by moles based on monomer contents.

### Example 11. Preparation of Emulsion Copolymer with VALMA

The polymer of Example 11 has the same components and was prepared in the same manner as Example 10, except the mole % of VALMA was increased from 0.012 to 0.018.

### Example 12. Comparative Copolymer Example Using DAAM

The polymer of Example 12 has the same components and was prepared in the same manner as Example 10 or 11, except the VALMA was replaced by 0.0185 moles of DAAM.

### Example 13. Comparative Polymer without VALMA

The polymer of Example 13 has the same components and was prepared in the same manner as Example 10, but without VALMA or any cross-linking monomer.

### Paint Example 14. Semigloss Paint Made with Copolymer Including VALMA

A paint was made with the polymer in Example 10 as shown in the table below.

| COMPONENTS | Mass (grams) |
|---|---|
| WATER | 85.0 |
| Biocide Solution 1 | 1.0 |
| Biocide Solution 2 | 2.5 |
| MILDEWCIDE Solution | 2.5 |
| Dispersant | 10.0 |
| Non-Ionic surfactant | 3.0 |
| Silicone Deformer 1 | 1.0 |
| TiO₂ Pigment | 265.0 |
| Kaolin Pigment | 20.0 |
| Calcined aluminum silicate Pigment | 12.0 |
| Mixing at 1800 RPM for 10 minutes | |
| Multifunctional Amino Alcohol (AEPD ™ VOX 1000) | 2.5 |
| anionic surfactant | 6.0 |
| Mid-Shear HEUR Rheology Modifier | 17.0 |
| non-film-forming synthetic pigment | 15.0 |
| Open time Additive | 0.0 |
| Coalescent aid | 19.0 |
| Silicone additive | 0.0 |
| adipic acid dihydrazone (37% active) | 13.0 |
| Polymer of Example 10 | 525 |
| Silicone Deformer 2 | 6.0 |
| High-Shear HEUR Rheology Modifier | 18.0 |
| Mid-Shear HEUR Rheology Modifier | 6.0 |
| Water | 42.5 |
| Total | 1072 |

Paint Examples 15, 16 and 17. Resin in the paint of Paint Example 14 was replaced by the polymers of Examples 11, 12 and 13, respectively. The amount of adipic acid dihydrazone was increased to 18 grams in Paint Examples 15 and 16. Paint Example 17 has no adipic acid dihydrazone.

Semigloss paint properties with resins made with VALMA, DAAM and no crosslinking resins.

| | | | | | | | | | | | | Block Res | |
|---|---|---|---|---|---|---|---|---|---|---|---|---|---|
| | Crosslinking Monomer | | | | Cleansability (DE) | | | | | | Track | (120° F.) | |
| Paint | | Mole % | Wt. % | Scrub | Coffee | Wine | Mustard | Ketchup | Graphite | Total | Resistance | 1 Day | 7 Day |
| Ex. 14 | VALMA | 0.012 | 2.8 | 855 | 0.84 | 0.05 | 0.37 | 0.17 | 1.26 | 2.69 | 46 | 4.5 | 5 |
| Ex. 15 | VALMA | 0.018 | 3.95 | 1200 | 1.08 | 0.18 | 0.11 | 0.32 | 1.65 | 3.34 | 45 | 4.5 | 5 |
| Ex. 16 | DAAM | 0.018 | 3.15 | 1372 | 3.56 | 0.3 | 0.14 | 0.35 | 2.16 | 6.51 | 42 | 1 | 3.5 |
| Ex. 17 | None | 0 | 0 | 725 | 0.08 | 0.09 | 0.29 | 1.25 | 1.25 | 3.00 | 69 | 1 | 1 |

Copolymers made with VALMA have improve block resistance, improved cleansability, acceptable scrubbability and tack resistance over non-crosslinked copolymer or copolymer with DAAM.

### Example 18. Copolymer Made with FMA

The polymer of Example 18 has the same components and was prepared in the same manner as Example 11, except that the 0.01800 moles of VALMA was replaced by FMA.

### Paint Example 19. Paint Properties with Resins Made with FMA

A semi-gloss paint was made with the same formula and process as in Paint Example 14, except that the polymer in example 18 replaced polymer in Example 10. The following table shows the properties in comparison to Paint Example 19 with a non-crosslinking resin of Paint Example 17.

| | | | | | | | | | | | | Block Res | |
|---|---|---|---|---|---|---|---|---|---|---|---|---|---|
| | Crosslinking Monomer | | | | Cleansability (DE) | | | | | | Tack | (120° F.) | |
| Paint | | Mole % | Wt. % | Scrub | Coffee | Wine | Mustard | Ketchup | Graphite | Total | Resistance | 1 Day | 7 Day |
| Ex. 19 | FMA | 0.018 | | 868 | 2.68 | 0.23 | 0.38 | 3.00 | 1.82 | 8.10 | 3 | 2 | 3 |
| Ex. 17 | None | 0 | 0 | 725 | 0.08 | 0.09 | 0.29 | 1.25 | 1.25 | 3.00 | 69 | 1 | 1 |

Paint Examples 17 and 19 show that the copolymer with FMA provides improved block resistance, tackiness and scrubbability over the copolymer without cross-linking monomer; however, with lower cleansability. These results agree with those from Paint Examples 7 and 8, discussed above.

The present inventors also conducted experiments with styrene replacing some of the (meth)acrylate monomers.

### Example 20. Styrene Acrylic Copolymer with VALMA

The polymer of Example 20 was prepared according to the following components with the same equipment and process as in Example 10.

| | |
|---|---|
| COMPONENTS | Mass (grams) |

Initial Charge in Reactor

| | |
|---|---|
| Deionized water | 792 |
| Sulfosuccinates (30% active) | 1.8 |
| Sodium bicarbonate | 2 |

Monomer Mix

| | |
|---|---|
| Deionized water | 732.5 |
| Sulfosuccinates (30% active) | 35.8 |
| Ethoxylated phosphate ester (25% active) | 70 |
| Methacrylic acid | 8.8 |
| N-(2-Methacryloyloxyethyl) ethylene urea (50% | 48.4 |
| active) | |
| 2-Ethylhexyl acrylate | 722.5 |
| Methyl methacrylate | 794.8 |
| Styrene (5.1 wt. % of all monomers) | 88.3 |
| Vanillin methacrylate | 70 |

Initiator Solution 1

| | |
|---|---|
| Sodium persulfate | 2.9 |
| Deionized water | 17.3 |

Initiator Solution 2

| | |
|---|---|
| Sodium persulfate | 0.7 |
| Deionized water | 21.6 |

Chaser solutions

| | |
|---|---|
| 1. Oxidizing agent - pre-mix | |
| t-butylperoxide | 1.4 |
| Deionized water | 19.8 |
| 2. Reducing agent - pre-mix | |
| Bruggolite ® FF6M | 1.4 |
| Deionized water | 19.8 |

Neutralizer - pre-mix

| | |
|---|---|
| Ammonium hydroxide (28%) | 5.1 |

Biocide - premix

| | |
|---|---|
| Acticide ® | 6.8 |
| Deionized water | 6.8 |
| Total | 3,470.5 |

### Example 21. Styrene Acrylic Copolymer with VALMA and DAAM

A styrene acrylic copolymer containing VALMA and DAAM was prepared with the formula and process in Example 20, except that 35 grams of DAAM was added to the monomer mix.

### Example 22. Comparative Polymer, Styrene Acrylic Copolymer without Self-Crosslinking Monomer

A styrene acrylic copolymer was prepared with the formula and process in Example 20, except that VALMA was removed from the monomer mix.

### Paint Example 23. Semigloss Paint Made with a Styrene Acrylic Copolymer Containing VALMA

A paint was made using the formula in Paint Example 14. The polymer of Example 10 was replaced by the Polymer of Example 20. The amount of adipic acid dihydrazone (37% active) was increased to 18 grams.

### Paint Example 24. Semigloss Paint Made with a Styrene Acrylic Copolymer Containing VALMA and DAAM

A paint was made using the formula of Paint Example 14. The polymer of Example 10 was replaced by the Polymer of Example 21. The amount of adipic acid dihydrazone (37% active) was increased to 24 grams.

### Paint Example 25: Semigloss Comparative Paint Made with a Styrene Acrylic Copolymer without Self-Crosslinking Monomer

A paint was made using the formula in Example 14. The polymer of Example 10 was replaced by the Polymer of Example 22. Adipic acid dihydrazone (37% active) was removed from the formula.

Block resistance and scrubbability of styrene acrylic copolymers containing self-crosslinking monomers from Paint Examples of 23, 24, and 25.

| | Crosslinking | 1 day block resistance | |
|---|---|---|---|
| Paint | Monomer | at 120° F. | Scrub |
| Example 23 | VALMA | 4 | 419 |
| Example 24 | VALMA and DAAM | 4 | 725 |
| Example 25 | No crosslinking | 1 (25% block) | 758 |
| | monomer | | |

Inventive Example 23 with VALMA has improved block resistance over Example 25, which used a copolymer without any cross-linking monomer, and the same block resistance as Example 24 which used a copolymer with DAAM in addition to VALMA. The copolymer with VALMA and DAAM has higher scrubbability than the copolymer with VALMA.

### Example 26. Acrylic Polymer Made with Zingerone Methacrylate (ZMA) in the 2-Stage Monomer Feed

An acrylic copolymer was prepared with the formula in Example 10 but without VALMA. When 50% of monomer mix was fed into the reactor, 98 grams of ZMA was added to the remaining monomer mix. The monomer mix then was continuously fed into the rector. The copolymer made with this process has ZMA in the 2-stage monomer feed.

Paint Example 27. A semigloss paint was made with the formula in Example 14 using the polymer of Example 26. The block resistance for 1-day dry paint film at 120° F. passed with a score of 3. The control without crosslinking monomer was blocked with a score of 1. Hence, the copolymer with the ZMA monomer has improved block resistance than the copolymer without crosslinking monomer.

Additional experiments were conducted to compare the 4-Acetyl-2-methoxyphenyl methacrylate (AVMA) crosslinking monomer to the DAAM monomer, as shown below.

### Example 28. Acrylic Copolymers Made 4-Acetyl-2-methoxyphenyl methacrylate (AVMA.)

A copolymer was made in a similar to the copolymer of Example 10, except that the 46.8 grams of VALMA was replaced with 72.3 grams of AVMA, which is 4.3 wt. % and 0.018 mole % based on monomers.

Paint Example 29. Semigloss paints made with the acrylic copolymer of Example 28. Comparative Paint Example 30 is made with an acrylic copolymer with DAAM instead of AVMA at the same mole %.

| Crosslinking | | | | Cleansability (DE) | | | | | |
|---|---|---|---|---|---|---|---|---|---|
| Monomer | wt. % | Mole % | Scrub | Coffee | Wine | Mustard | Ketchup | Graphite | Total |
| DAAM | 3.15 | 0.018 | 1387 | 2.15 | 1.4 | 0.1 | 0.11 | 0.31 | 4.07 |
| AVMA | 4.3 | 0.018 | 1557 | 1.6 | 1.11 | 0.1 | 0.09 | 0.34 | 3.24 |

| | | | | | Water | | | Block |
|---|---|---|---|---|---|---|---|---|
| Crosslinking | | | Scuff (DE) | | Sensitivity/ | Water | Tack | Resist |
| Monomer | wt. % | Mole % | Un-clean | Clean | min | Staining | Resist | (120° F.) |
| DAAM | 3.15 | 0.018 | 11.21 | 1.64 | 3 very hard/3 | 2 | 28 | 4 |
| AVMA | 4.3 | 0.018 | 13.1 | 2.7 | 3 very hard/3 | 4 | 32 | 4 |

The scrubbability and cleansability of the paint examples using polymer with AVMA are better than those for the polymer with DAAM. Both copolymers have comparable scuff resistance, water sensitivity, water staining resistance, tack resistance and block resistance. The copolymer with DAAM has slightly better scuff resistance.

From the experiments discussed herein, the ranges of the bio-based cross-linkable monomers or their synthetic analogues, including FMA, ZMA, VALMA and AVMA, in the copolymers are from about 0.008 mole % to about 0.025 mole %, preferably from about 0.010 mole % to about 0.0225%, preferably from about 0.010 mole % to about 0.020 mole % based on total monomers in the copolymers.

Alternatively, the ranges of the bio-based cross-linkable monomers or their synthetic analogues, including FMA, ZMA, VALMA and AVMA, in the copolymers are from about 2.0 wt. % to about 6.0 wt. %, preferably from about 2.25 wt. % to about 5.5 wt. %, preferably from about 2.5 wt. % to about 5.0 wt. % based on total monomers in the copolymers.

### Industrial Availability of Synthetic Versions of Bio-Based Monomers in Commercial Architectural Compositions

The bio-based components in the bio-based self-cross-linkable monomers described herein are originally extracted or isolated from agricultural products, such as vanilla plantifolia beans, raspberries, cranberries, blackberries and gingers, etc., that are not available in the industrial scale necessary to support the production of architectural compositions, such as paints and wood stains. In a more preferred embodiment of the present invention, the agricultural components in the bio-based self-cross-linkable monomers are wholly or at least partially replaced by industrial available components, which can be other bio-based components or synthesized from hydrocarbons, fossil fuel sources or other sources. The bio-based self-cross-linkable monomers described herein are preferably formulated from these substituted, industrially available components, which are referred to as synthetic analogues of the bio-based self-cross-linkable monomers.

Vanillin can be synthesized from more readily available natural components. Artificial vanillin can be manufactured from eugenol (4-allyl-2-methoxyphenol) from the oil in cloves, and more recently from lignin or guaiacol. Lignin and cellulose are wood organic polymers, and lignin forms the support tissues in plants. Lignin can be found in the waste byproduct from the preparation of wood pulp in the papermaking industry. Lignin if remains in the wood pulp would cause the papers to yellow with age. The lignin byproduct separated from the wood pulp is typically burned as fuel for papermills. Lignin can be reacted in an electrochemical process to produce vanillin. Electrochemical processes to produce vanillin from lignin are described in M. Breiner, J. Strugatchi, S. R. Waldvogel “Vanillin from Lignin,” Wiley Analytical Science Magazine, 14 Jun. 2021, (available at https://analyticalscience.wiley.com/do/10.1002/was.00170197), which is incorporated herein by reference in its entirety.

Synthetic or artificial vanillin can also be produced from a petrochemical process. In a multi-stage process, benzene is converted to guaiacol, which is then reacted with glyoxylic acid to form vanillin. See M. Breiner et al. This process uses fossil resources and can produce vanillin in industrial scale.

Acetovanillone is a component in the lignin production process, and can be extracted from the same process.

Raspberry ketone can be synthesized by the crossed-aldol condensation of 4-hydroxybenzaldehyde with acetone to produce an adduct (4-(4′-hydroxyphenyl)-3-buten-2-one), which is hydrogenated over rhodium on alumina, and zingerone can be synthesized by the condensation vanillin with acetone to produce 4-(4′-hydorxy-3′-methoxyphenyl)-3-buten-2-one, which is hydrogenated. See Smith, L. R., Rheosmin (“Raspberry Ketone”) and Zingerone, and Their Preparation by Crossed Aldol-Catalytic Hydrogenation Sequences. Chem. Educator 1, 1-18 (1996). The Smith reference is incorporated herein by reference in its entirety.

### Commercial Viability of Bio-Based Monomers in Commercial Architectural Compositions

To form a stronger solid paint film from aqueous architectural compositions, a conventional cross-linkable monomer, such as diacetone acrylamide (DAAM) and acetoacetoxyethyl methacrylate (AAEM), is copolymerized with other monomers, such as acrylic, vinyl, styrene and/or urethane monomers, to form latex resin binders. After the architectural compositions are applied, e.g., painted or spread, to a substrate and the aqueous phase evaporates, the DAAM or AAEM moiety utilizing its ketone reaction site reacts in the aqueous phase with a crosslinking compound, such as a diamine or a dihydrazide compound, to self-crosslink the latex resins to form stronger paint films, e.g., films with higher resistance to scrubbing, during evaporation or air-drying of the architectural compositions. Such cross-linking or self-cross-linking mechanism is discussed in commonly owned U.S. Pat. No. 9,040,617 B2, which is incorporated herein by reference in its entirety.

Other crosslinking mechanisms or monomers for architectural coatings are also discussed in the literature. An article, Self-Crosslinking Surfactant-Free Acrylic Dispersions for High-Performance Coatings Applications, PCIMag 31 Jul. 2001, which is available at https://www.pcimag.com/articles/86493-self-crosslinking-surfactant-free-acrylic-dispersions-for-high-performance-coatings-applications, (hereinafter PCIMag article) reported that cross-linking is effective to improve chemical resistance of the paint film. This article reported that self-crosslinking, where all the reactive components are present in the aqueous composition and are long-term storage stable, is triggered by the evaporation of water upon drying. “Examples of suitable crosslinking systems are the reaction of azeridines with acid groups on the polymer backbone, the reaction of OH functionality on the backbone with post added isocyanates or melamines, the reaction of amines with epoxy functionality where either can be on the polymer backbone, the auto-oxidation of incorporated fatty acid groups, the self-condensation of alkoxy-silane functionality, the self-condensation of n-methylolacrylamide, metal-ion coordination with backbone functional groups such as acetoacetoxy groups or acid groups, and the reaction of acetoacetoxy groups with amines or acetoacetoxy groups with unsaturated groups in a Michael reaction” (internal citations omitted). This article, however, concluded that self-crosslinking polymeric surfactants is an effective way to prepare surfactant-free acrylic dispersions.

Another article, Crosslinking Technology for Fast-Curing, High-Performance, Low-VOC Coatings, PCIMag, 1 Oct. 2001, which is available at https://www.pcimag.com/articles/86518-crosslinking-technology-for-fast-curing-high-performance-low-voc-coatings, acknowledged that cross-linking while the architectural coating is air-dried is the most common crosslinking method, but discussed ultra violet/electron beam, peroxide and amine (using Michael Addition reaction chemistry) curing techniques as the most effective curing techniques.

Commonly owned U.S. Pat. No. 9,115,265 discloses that DAAM, diacetone methacrylamide (DAMAM) or AAEM can be copolymerized with a methacrylamide (MAM) or acrylamide monomer and other film forming monomer(s) to provide crosslinking with or without ADH. U.S. Pat. No. 10,190,002 discloses a crosslinking by a copolymer including DAAM and one or more phosphorous acid monomers in an aqueous composition containing ADH.

Furthermore, U.S. Pat. No. 11,161,990 discloses “crosslinking agents [monomers], such as alkylene glycol diacrylates and dimethacrylates, such as for example, ethylene glycol diacrylate, ethylene glycol dimethacrylate, 1,3-butylene glycol diacrylate, 1,4-butylene glycol diacrylate propylene glycol diacrylate and triethylene glycol dimethylacrylate; 1,3-glycerol dimethacrylate; 1,1,1-trimethylol propane dimethacrylate; 1,1,1-trimethylol ethane diacrylate; pentaerythritol trimethacrylate; 1,2,6-hexane triacrylate; sorbitol pentamethacrylate; methylene bis-acrylamide, methylene bis-methacrylamide, divinyl benzene, vinyl methacrylate, vinyl crotonate, vinyl acrylate, vinyl acetylene, trivinyl benzene, triallyl cyanurate, divinyl acetylene, divinyl ethane, divinyl sulfide, divinyl ether, divinyl sulfone, diallyl cyanamide, ethylene glycol divinyl ether, diallyl phthalate, divinyl dimethyl silane, glycerol trivinyl ether, divinyl adipate; dicyclopentenyl (meth)acrylates; dicyclopentenyloxy (meth)acrylates; unsaturated esters of glycol monodicyclopentenyl ethers; allyl esters of α,β-unsaturated mono- and dicarboxylic acids having terminal ethylenic unsaturation including allyl methacrylate, allyl acrylate, diallyl maleate, diallyl fumarate, [and] diallyl itaconate.”

Notwithstanding a plethora of known crosslinking monomers and crosslinking systems, DAAM and AAEM remain the most commonly used crosslinking monomers with ADH for various reasons, including but not limited to crosslinking effectiveness. Patents assigned to major paint manufacturers consistently list these two monomers as the preferred crosslinking monomers, see e.g., the examples contained in patent Nos. U.S. Pat. Nos. 11,136,468; 9,175,187; 8,980,995; etc.

The utility of the bio-based monomers and similar monomers discussed herein as a cross-linkable monomer in film-forming latex resins in paints, stains and other architectural compositions is heretofore known, due to the fact their ability to cross-link compared to the DAAM and/or AAEM monomer has not yet been established. Additionally, while bio-based and renewable monomers are commercially available, e.g., vanillin, raspberry and ginger, they are not widely used in architectural compositions. Hence, the efficacy of cross-linkable monomers, preferably bio-based cross-linkable monomers, need to be determined relative to DAAM and/or AAEM in architectural coating compositions.

As discussed in the PCIMag article, crosslinking particularly in waterborne or aqueous low-VOC acrylic dispersions provides certain benefits to the dry paint films, including hardness, scratch resistance, anti-blocking, resistance against household chemicals and grease and flexibility and toughness. DAAM and AAEM monomers are widely used instead of the other crosslinking monomers due to the benefits they confer on paint films. Commercially useful or practical crosslinking monomers need to perform as well as, or significantly similar to DAAM and/or AAEM. DAAM is more widely used and makes a practical benchmark for crosslinking monomers.

To be commercially viable, bio-based cross-linkable monomers need to perform comparably to DAAM. In accordance with one aspect of the present invention, a set of metrics is established to determine whether a bio-based monomer can be used either fully or partially in place of DAAM in architectural compositions, such as paints and stains.

The metrics for this comparison are set forth below. Where there are multiple readings, measurements, etc., average values are used.

If the scrubbability of copolymers with a bio-based crosslinking monomer is within 20%, preferably within 15%, preferably within 10%, in terms of the number of cycles of the copolymer with DAAM at the same or substantially the same (i.e., ±5%) mole percentage, then it is acceptable. The scrubbability is also acceptable if the result is greater than 1,000 cycles.

If the cleansability of the copolymers with a bio-based crosslinking monomer is less than 2.0 CIEDE2000 units as measured with a spectrophotometer, or has a lower reading with a spectrophotometer than that of the copolymer with DAAM at the same or substantially the same (i.e., ±5%) mole percentage, then it is acceptable.

If the tack resistance, which is a measured adhesive force between two painted surfaces facing each other, of the copolymers with a bio-based crosslinking monomer is the same or better, or within 7.5 units, preferably within 5 units, preferably within 2.5 units, of that of the copolymer with DAAM at the same or substantially the same (i.e., ±5%) mole percentage, then it is acceptable.

If the block resistance of the copolymers with a bio-based crosslinking monomer is the same as or better than, or is within 1.0 unit of that of the copolymer with DAAM at the same or substantially the same (i.e., ±5%) mole percentage, then it is acceptable.

If at least two out of the four parameters, i.e., scrubbability, cleansability, tack resistance and block resistance, are acceptable, then the copolymer(s) with a bio-based crosslinking monomer is/are suitable as copolymer resin for aqueous architectural compositions.

These novel metrics are applied to the paint examples utilizing copolymers with FMA, VALMA, ZMA and AVMA.

From Paint Examples 7 and 9, the copolymer with FMA crosslinking monomer has acceptable tack resistance (1 vs. 20 and 3 vs. 2) and block resistance (2 vs. 2 and 2 vs. 3), and better cleansability (8.11 vs. 10.42) than the copolymer with DAAM at the same mole %, albeit lower scrubbability but above 1,000 cycles. Hence, copolymers with FMA are acceptable copolymer resins and FMA is an acceptable crosslinking monomer for aqueous architectural compositions (4 acceptable ratings out of 4 ratings).

From Paint Examples 14-16, the copolymer with VALMA monomer at both mole percentages exceeds the copolymer with DAAM at cleansability (2.69 and 3.34 vs. 6.51) and block resistance (4.5/5 and 4.5/5 vs. 3.5), and acceptable tack resistance (46 and 45 vs. 42). The copolymer with VALMA at 0.018 mole % is within

$$15 \% \{ \frac{1372 - 1200}{1372} \}$$

of the scrubbability of the copolymer with DAAM at 0.018 mole %, and is greater than 1,000 cycles. Copolymers made with VALMA have improved block resistance and improved cleansability over the copolymer made with DAAM, and acceptable scrubbability and acceptable tack resistance relative to copolymer with DAAM. Hence, copolymers with VALMA are acceptable copolymer resins and VALMA is an acceptable crosslinking monomer for aqueous architectural compositions (4 acceptable ratings out of 4 ratings).

The copolymer with ZMA would be analyzed in the same manner as the other copolymers with bio-based monomers discussed herein.

From Paint Examples 29 and 30, the copolymer with AVMA monomer has improved scrubbability (1557 vs. 1387) and cleansability (3.24 vs. 4.07) than those for the copolymer with DAAM. Both copolymers have comparable tack resistance (32 vs. 28) and block resistance (4 vs. 4). Hence, copolymers with AVMA are acceptable copolymer resins and AVMA is an acceptable crosslinking monomer for aqueous architectural compositions (4 acceptable ratings out of 4 ratings).

### Description of the Tests of the Paint Films Conducted in the Examples

Cleansability test is conducted on a 7-mil (wet) draw down on a Leneta dull plastic Scrub panel (P-121-10N) in a constant temperature and humidity room at 73° F. and 50% relative humidity. The draw down was allowed to dry for 7 days.

Household stains, graphite, tomato ketchup, yellow mustard, red cooking wine, and coffee, were applied on the surface of the draw down scrub panel. After 10 minutes, the panel was rinsed with tap water and dried by gentle wiping with a cellulose sponge. The scrub panel was mounted on a TQC AB5000 Washability machine, and washed with a sponge soaked with soap/water solution for 500 cycles. After washing, the panel was rinsed with water and dried for 24 hours. A spectrophotometer was used to measure the color difference, Delta E (DE), between stained and washed areas against unstained and washed area. A smaller DE indicates better cleansability of stains on paints.

The tackiness of paint films was tested with a Brookfield CT3 Texture Analyzer on a 3 mil (wet) draw down on BYK Byko-charts Plaint white sealed chart #2837. The drawdowns were allowed to dry for 1 or 7 days at a constant temperature and humidity room at 77° F. and 50% relative humidity. The adhesive force in grams is recorded in number. For each sample, three readings are recorded for each sample. An average of three readings is reported as the tackiness number. A lower tackiness number indicates the less tacky for the paint, and better performance in tack resistance

Block resistance test was conducted using a Modified ASTM D4946. A paint drawdown was prepared on a sealed white Leneta WK card on a vacuum plate. The draw down was dried for 1 and 7 days at a constant temperature and humidity room at 25° C. and 50% humidity. One-inch squares were cut out of the panel and two squares were placed face to face. A 100-gram cubic weight was placed on top and was put in 120° F. for 24 hours. The sample was removed from oven & let panels cool for ½ hour. Fusion of samples was checked by pulling both panels apart in a slow & steady force. Ratings of blocking resistance is given by 5—no tack; 4—slight tack; 3—moderate tack; 2—poor tack; 1—transfer (note the % of film removed).

Scrub resistance test was done using ASTM D2486 Method B. The test was done on a 7-mil drawdown of paint dried for 7 days. A TQC Scrub Abrasion and Washability Tester with a boat weighing 340 grams was used for the test. The scrub cycle number at failure was recorded (where the paint film was removed, and the surface of the underlying substrate shows through). A higher number from the reading indicates better scrub resistance of the paint.

Water staining test was done on 3-mil bird bar drawdowns of paint dried for one day at ambient conditions. A few drops of water were placed on the surface of paint on the draw down. The draw down was then placed vertically to let the water run down the surface of the paint. The draw down was then examined next day for water stains due to the surfactant leaching. A rating from 1 to 5 was given with 1 being worse and 5 being best.

The term water sensitivity refers to the tendency of a paint to be degraded as a consequence of contact with water. This sensitivity, and conversely resistance to it, can be measured on drawdowns dried for a controlled duration of time. A few drops of water can be deposited on the paint surface for a suitable time period. The water is wiped off and the wetted surface scratched with a fingernail to check the hardness of the film. The paint surface is rated from 1 to 5, with 5 designating the hardest film, and thus indicating the least amount of water sensitivity.

Scuff resistance is measured by the method described in commonly owned U.S. Pat. No. 11,230,645, which is incorporated herein by reference in its entirety. Unless otherwise indicated, the height from which the black heel drops in 12 inches.

All the paint examples presented herein have semigloss finish.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments, which would come within the spirit and scope of the present invention.

We claim:

1. An aqueous architectural coating comprising an optional opacifying pigment, a film-forming copolymer resin, and a diamine or a dihydrazide compound dispersed in an aqueous phase,
wherein the film-forming copolymer resin includes at least one film-forming monomer, and a cross-linkable monomer with a structure: 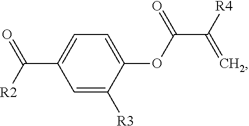
where R2 is H or CH₃; R3 is OCH₃; and R4 is CH₃,
wherein the cross-linkable monomer is a synthetic analogue of the bio-based monomer, and wherein the at least one film-forming monomer comprises a (meth)acrylate monomer and an optional styrene monomer, and
wherein the copolymer resin is capable of forming a film on a substrate after the aqueous architectural coating is applied on said substrate and the aqueous phase evaporates.

2. The aqueous architectural coating of claim 1, wherein the synthetic analogue of the bio-based cross-linkable monomer in the film-forming copolymer resin ranges from about 0.008 mole % to about 0.025 mole % based on total monomers in the film-forming copolymer resin.

3. The aqueous architectural coating of claim 2, wherein the synthetic analogue of the bio-based cross-linkable monomer in the film-forming copolymer resin ranges from about 0.010 mole % to about 0.0225 mole % based on total monomers in the film-forming copolymer resin.

4. The aqueous architectural coating of claim 2, wherein the synthetic analogue of the bio-based cross-linkable monomer in the film-forming copolymer resin ranges from about 0.010 mole % to about 0.020 mole % based on total monomers in the film-forming copolymer resin.

5. The aqueous architectural coating of claim 1, wherein the synthetic analogue of the bio-based cross-linkable monomer in the film-forming copolymer resin ranges from about 2.0 wt. % to about 6.0 wt. %, based on total monomers in the film-forming copolymer resin.

6. The aqueous architectural coating of claim 5, wherein the synthetic analogue of the bio-based cross-linkable monomer in the film-forming copolymer resin ranges from about 2.25 wt. % to about 5.5 wt. %, based on total monomers in the film-forming copolymer resin.

7. The aqueous architectural coating of claim 6, wherein the synthetic analogue of the bio-based cross-linkable monomer in the film-forming copolymer resin ranges from about 2.5 wt. % to about 5.0 wt. % based on total monomers in the film-forming copolymer resin.

8. An aqueous architectural coating comprising an optional opacifying pigment, a film-forming copolymer resin, and a diamine or a dihydrazide compound dispersed in an aqueous phase,
wherein the film-forming copolymer resin includes at least one film-forming monomer, and a cross-linkable monomer with either the following structure: 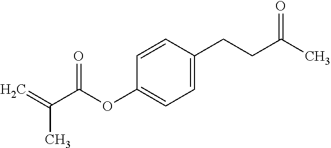 [SMILES: C=C(C)C(=O)Oc1ccc(CCC(C)=O)cc1]
or the following structure 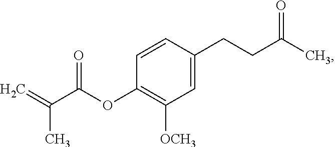 [SMILES: C=C(C)C(=O)Oc1ccc(CCC(C)=O)cc1OC]
wherein the cross-linkable monomer is a synthetic analogue of the bio-based monomer, and wherein the at least one film-forming monomer comprises a (meth)acrylate monomer and an optional styrene monomer, and
wherein the copolymer resin is capable of forming a film on a substrate after the aqueous architectural coating is applied on said substrate and the aqueous phase evaporates.

9. The aqueous architectural coating of claim 8, wherein the synthetic analogue of the bio-based cross-linkable monomer in the film-forming copolymer resin ranges from about 0.008 mole % to about 0.025 mole % based on total monomers in the film-forming copolymer resin.

10. The aqueous architectural coating of claim 9, wherein the synthetic analogue of the bio-based cross-linkable monomer in the film-forming copolymer resin ranges from about 0.010 mole % to about 0.0225 mole % based on total monomers in the film-forming copolymer resin.

11. The aqueous architectural coating of claim 10, wherein the synthetic analogue of the bio-based cross-linkable monomer in the film-forming copolymer resin ranges from about 0.010 mole % to about 0.020 mole % based on total monomers in the film-forming copolymer resin.

12. The aqueous architectural coating of claim 8, wherein the synthetic analogue of the bio-based cross-linkable monomer in the film-forming copolymer resin ranges from about 2.0 wt. % to about 6.0 wt. %, based on total monomers in the film-forming copolymer resin.

13. The aqueous architectural coating of claim 12, wherein the synthetic analogue of the bio-based cross-linkable monomer in the film-forming copolymer resin ranges from about 2.25 wt. % to about 5.5 wt. %, based on total monomers in the film-forming copolymer resin.

14. The aqueous architectural coating of claim 13, wherein the synthetic analogue of the bio-based cross-linkable monomer in the film-forming copolymer resin ranges from about 2.5 wt. % to about 5.0 wt. % based on total monomers in the film-forming copolymer resin.

15. A method for selecting a bio-based cross-linkable monomer with respect to a diacetone acrylamide (DAAM) monomer, wherein the bio-based cross-linkable monomer is copolymerized to form a bio-based film-forming copolymer resin capable of crosslinking using the diamine or dihydrazide compound to form a bio-based paint film on a substrate, said method comprises the steps of
(i) ascertaining a scrubbability of the bio-based paint film, wherein if said scrubbability is greater than 1,000 cycles, or is within 20%, preferably within 15%, preferably within 10%, in terms of the number of cycles of a standard paint film formed with a standard film-forming copolymer resin with DAAM, then the scrubbability is acceptable;
(ii) ascertaining a cleansability of the bio-based paint film, wherein if said cleansability is less than 2.0 CIEDE2000 units, or has a lower reading with a spectrophotometer than that of the standard paint film, then the cleansability is acceptable;
(iii) ascertaining a tack resistance of the bio-based paint film, wherein if said tack resistance is within 7.5 units, preferably within 5 units, preferably within 2.5 units, of the tack resistance of the standard paint film, then the tack resistance is acceptable;
(iv) ascertaining the block resistance of the bio-based paint film, wherein if said block resistance is the same as, or better than, or is within 1.0 unit of the block resistance of the standard paint film, then the block resistance is acceptable
wherein if the bio-based paint film possesses at least two acceptable ratings out of four in steps (i)-(iv), as compared to the standard paint film, then said bio-based cross-linkable monomer is acceptable, and
wherein the DAAM crosslinking monomer is present in the standard film-forming copolymer resin within ±5% mole percentage as the bio-based cross-linkable monomer is present in the bio-based film-forming copolymer resin.

16. The method of claim 15, wherein the bio-based cross-linkable monomer also comprises a synthetic analogue thereof.

17. A bio-based film-forming copolymer resin selected in accordance with the method of claim 16.
